(19) United States
(12) Patent Application Publication
(10) Pub. No.: US 2023/0419349 A1
(43) Pub. Date: Dec. 28, 2023

(54) METHODS AND APPARATUS TO ESTIMATE CENSUS-LEVEL AUDIENCE SIZES AND DURATION DATA ACROSS DIMENSIONS AND/OR DEMOGRAPHICS

(71) Applicant: The Nielsen Company (US), LLC, New York, NY (US)

(72) Inventors: Michael R. Sheppard, Holland, MI (US); Beate Sissenich, New York, NY (US); Robert C. Smith, Chicago, IL (US); Preema D'Souza, Udupi (IN); Tony Kappen, Clearwater, FL (US); Prahlad Agnihotri, Bangalore (IN); Shreyas Saiprasad Jadhav, New York, NY (US); Stephanie Sherman, Chicago, IL (US)

(21) Appl. No.: 17/948,873

(22) Filed: Sep. 20, 2022

(30) Foreign Application Priority Data
May 4, 2022 (IN) 202211026051

(51) Int. Cl. G06Q 30/02

(52) U.S. Cl. CPC G06Q 30/0204; G06Q 30/0246

(57) ABSTRACT

Methods and apparatus to estimate census-level audience sizes and duration data across dimensions and/or demographics are disclosed. An example apparatus includes constraint equation control circuitry to select at least one constraint equation corresponding to one or more events, the one or more events corresponding to first audience members and second audience members, the first audience members to include the second audience members, constraint parameter estimation circuitry to solve the at least one constraint equation to determine one or more constraint parameter values, the one or more constraint parameter values corresponding to the one or more events, and output generation circuitry to determine, based on one or more intermediate equations and the one or more constraint parameter values, an event audience size and an event duration corresponding to (a) the first audience members and (b) a combination of the one or more events and one or more demographics.

### RELATED APPLICATION

This patent claims priority to Indian Provisional Patent Application No. 202211026051, which was filed on May 4, 2022. Indian Provisional Patent Application No. 202211026051 is hereby incorporated herein by reference in its entirety. Priority to Indian Provisional Patent Application No. 202211026051 is hereby claimed.

### FIELD OF THE DISCLOSURE

This disclosure relates generally to computer-based audience monitoring and, more particularly, to methods and apparatus to estimate census-level audience sizes and duration data across dimensions and/or demographics.

### BACKGROUND

Traditionally, audience measurement entities have measured audience engagement levels for media based on registered panel members. That is, an audience measurement entity (AME) enrolls people who consent to being monitored into a panel. The AME then monitors those panel members to determine media (e.g., television programs, radio programs, movies, digital video discs or digital versatile discs (DVDs), advertisements, streaming media, websites, etc.) presented to those panel members. In this manner, the AME can determine exposure metrics for different media based on the collected media measurement data.

Techniques for monitoring user accesses to Internet resources, such as webpages, advertisements and/or other Internet-accessible media, have evolved significantly over the years. Internet-accessible media is also known as online media. Some known systems perform such monitoring primarily through server logs. In particular, entities serving media on the Internet can use known techniques to log the number of requests received at their servers for media.

### BRIEF DESCRIPTION OF THE DRAWINGS

FIG. 1 illustrates example audience estimate control circuitry for estimating census audience size and duration data across dimensions and/or demographics in accordance with teachings of this disclosure.

FIG. 2 illustrates example client devices that report audience impression requests for Internet-based media to impression collection entities to facilitate estimating sizes of audiences that access different Internet-based media.

FIG. 3 is a block diagram of the example audience estimate control circuitry of FIGS. 1 and/or 2.

FIG. 4 is a flowchart representative of example machine readable instructions and/or example operations that may be executed by example processor circuitry to implement the audience estimate control circuitry of FIG. 3.

FIG. 5 is a flowchart representative of example machine readable instructions and/or example operations that may be executed by example processor circuitry to determine output parameters including census audience sizes and census durations.

FIG. 6 is a flowchart representative of example machine readable instructions and/or example operations that may be executed by example processor circuitry to estimate census audience sizes and census durations.

FIG. 7 is a block diagram of an example processing platform including processor circuitry structured to execute the example machine readable instructions and/or the example operations of FIGS. 4, 5, and/or 6 to implement the example audience estimate control circuitry of FIG. 3.

FIG. 8 is a block diagram of an example implementation of the processor circuitry of FIG. 7.

FIG. 9 is a block diagram of another example implementation of the processor circuitry of FIG. 7.

FIG. 10 is a block diagram of an example software distribution platform (e.g., one or more servers) to distribute software (e.g., software corresponding to the example machine readable instructions of FIGS. 4, 5, and/or 6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time +/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs. one or more CPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Techniques for monitoring user access to an Internet-accessible media, such as digital television (DTV) media, digital advertisement ratings (DAR), and digital content ratings (DCR) media, have evolved significantly over the years. Internet-accessible media is also known as digital media. In the past, such monitoring was done primarily through server logs. In particular, entities serving media on the Internet would log the number of requests received for their media at their servers. Basing Internet usage research on server logs is problematic for several reasons. For example, server logs can be tampered with either directly or via zombie programs, which repeatedly request media from the server to increase the server log counts. Also, media is sometimes retrieved once, cached locally and then repeatedly accessed from the local cache without involving the server, Server logs cannot track such repeat views of cached media. Thus, server logs are susceptible to both over-counting and under-counting errors.

The inventions disclosed in Blumenau, U.S. Pat. No. 6,108,637, which is hereby incorporated herein by reference in its entirety, fundamentally changed the way Internet monitoring is performed and overcame the limitations of the server-side log monitoring techniques described above. For example, Blumenau disclosed a technique wherein Internet media to be tracked is tagged with monitoring instructions. In particular, monitoring instructions are associated with the hypertext markup language (HTML) of the media to be tracked. When a client device requests the media, both the media and the monitoring instructions are downloaded to the client device. The monitoring instructions are, thus, executed whenever the media is accessed, be it from a server or from a cache. Upon execution, the monitoring instructions cause the client device to send or transmit monitoring information from the client device to a media provider site. The monitoring information is indicative of the manner in which media was displayed.

In some implementations, an impression request or ping request can be used to send or transmit monitoring information by a client device using a network communication in the form of a hypertext transfer protocol (HTTP) request. In this manner, the impression request or ping request reports the occurrence of a media impression at the client device. For example, the impression request or ping request includes information to report access to a particular item of media (e.g., an advertisement, a webpage, an image, video, audio, etc.). In some examples, the impression request or ping request can also include a cookie previously set in the browser of the client device that may be used to identify a user that accessed the media. That is, impression requests or ping requests cause monitoring data reflecting information about an access to the media to be sent from the client device that downloaded the media to a monitoring entity and can provide a cookie to identify the client device and/or a user of the client device. In some examples, the monitoring entity is an audience measurement entity (AME) that did not provide the media to the client and who is a trusted (e.g., neutral) third party for providing accurate usage statistics (e.g., The Nielsen Company, LLC). Since the AME is a third party relative to the entity serving the media to the client device, the cookie sent to the AME in the impression request to report the occurrence of the media impression at the client device is a third-party cookie. Third-party cookie tracking is used by measurement entities to track access to media accessed by client devices from first-party media servers.

There are many database proprietors operating on the Internet. These database proprietors provide services to large numbers of subscribers. In exchange for the provision of services, the subscribers register with the database proprietors. Examples of such database proprietors include social network sites (e.g., Facebook, Twitter, MySpace, etc.), multi-service sites (e.g., Yahoo!, Google, Axiom, Catalina, etc.), online retailer sites (e.g., Amazon.com, Buy.com, etc.), credit reporting sites (e.g., Experian), streaming media sites (e.g., YouTube, Hulu, etc.), etc. These database proprietors set cookies and/or other device/user identifiers on the client devices of their subscribers to enable the database proprietors to recognize their subscribers when they visit their web sites.

The protocols of the Internet make cookies inaccessible outside of the domain (e.g., Internet domain, domain name, etc.) on which they were set. Thus, a cookie set in, for example, the facebook.com domain (e.g., a first party) is accessible to servers in the facebook.com domain, but not to servers outside that domain. Therefore, although an AME (e.g., a third party) might find it advantageous to access the cookies set by the database proprietors, they are unable to do so.

The inventions disclosed in Mazumdar et al., U.S. Pat. No. 8,370,489, which is incorporated by reference herein in its entirety, enable an AME to leverage the existing databases of database proprietors to collect more extensive Internet usage by extending the impression request process to encompass partnered database proprietors and by using such partners as interim data collectors. The inventions disclosed in Mazumdar accomplish this task by structuring the AME to respond to impression requests from client devices (who may not be member of an audience measurement panel and, thus, may be unknown to the AME) by redirecting the client devices from the AME to a database proprietor, such as a social network site partnered with the AME, using an impression response. Such a redirection initiates a communication session between the client device accessing the tagged media and the database proprietor. For example, the impression response received at the client device from the AME may cause the client device to send a second impression request to the database proprietor. In response to the database proprietor receiving this impression request from the client device, the database proprietor (e.g., Facebook) can access any cookie it has set on the client device to thereby identify the client device based on the internal records of the database proprietor. In the event the client device corresponds to a subscriber of the database proprietor, the database proprietor logs/records a database proprietor demographic impression association with the user/client device.

As used herein, an impression or media impression is defined to be an event in which a home or individual accesses and/or is exposed to media (e.g., an advertisement, content, a group of advertisements, a collection of content, a movie, a movie trailer, a song, a web page banner, a webpage, etc.). In Internet media delivery, a quantity of impressions or impression count is the total number of times media (e.g., content, an advertisement, or advertisement campaign) has been accessed by a web population or audience members (e.g., the number of times the media is accessed). In some examples, an impression or media impression is logged by an impression collection entity (e.g., an AME or a database proprietor) in response to an impression request from a user/client device that requested the media. For example, an impression request is a message or communication (e.g., an HTTP request) sent by a client device to an impression collection server to report the occurrence of a media impression at the client device. In some examples, a media impression is not associated with demographics. In non-Internet media delivery, such as television (TV) media, a television or a device attached to the television (e.g., a set-top-box or other media monitoring device) may monitor media being output by the television. The monitoring generates a log of impressions associated with the media displayed on the television. The television and/or connected device may transmit impression logs to the impression collection entity to log the media impressions.

In examples disclosed herein, the term duration corresponds to an aggregate or total of the individual exposure times associated with impressions during a monitoring interval. For example, the aggregation or total can be at the individual level such that a duration is associated with an individual, the aggregation or total can be at the demographic level such that the duration is associated with a given demographic, the aggregation or total can be at the population level such that the duration is associated with a given population universe, etc. In examples disclosed herein, the duration of audience exposure tier an individual may be logged over a measurement interval, but the actual number of impressions themselves may be unknown, given that an individual can watch, for example, between 20 to 30 minutes of different videos during a measurement interval, but the total impressions (e.g., number of individual videos watched) during the measurement interval is unknown.

A user of a computing device (e.g., a mobile device, a tablet, a laptop, etc.) and/or a television may access the same media via multiple devices (e.g., two or more of a mobile device, a tablet, a laptop, etc.) and/or via multiple media types (e.g., digital media available online, digital TV (DTV) media temporality available online after broadcast, TV media, etc.). For example, a user may start watching the Walking Dead television program on a television as part of TV media, pause the program, and continue to watch the program on a tablet as part of DTV media. In such an example, the access of the program may be logged by an AME twice, once for an impression log associated with the television access, and once for the impression request generated by a tag (e.g., a census measurement science (CMS) tag) executed on the tablet. Multiple logged impressions associated with the same program and/or same user are defined as duplicate impressions. Duplicate impressions are problematic in determining total reach estimates because one exposure via two or more cross-platform devices may be counted as two or more unique audience members. As used herein, reach is a measure indicative of the demographic coverage achieved by media (e.g., demographic group(s) and/or demographic population(s) exposed to the media). For example, media reaching a broader demographic base will have a larger reach than media that reached a more limited demographic base. The reach metric may be measured by tracking impressions for known users (e.g., panelists) for which an audience measurement entity stores demographic information or unknown users (e.g., non-panelists or census audience) for which the audience measurement entity may be able to estimate and/or obtain demographic information. Deduplication is a process to adjust cross-platform media exposure totals by substantially reducing or eliminating the double counting of individual audience members that accessed media via more than one platform and/or are represented in more than one database of media impressions used to determine the reach of the media.

As used herein, a unique audience is based on audience members distinguishable from one another. That is, a particular audience member that accessed particular media is measured as a single unique audience member regardless of how many times that audience member accesses that particular media or the particular platform(s) through which the audience member accessed the media. If that particular audience member accesses the same media multiple times, the multiple accesses by the particular audience member of the same media is counted as only a single unique audience member. As used herein, an audience size is a quantity of unique audience members of particular events, As used herein, an event represents an access or exposure to a media item for some duration. That is, while an impression (e.g., a media impression) represents an instance or a count of an access or exposure to a media item by an audience member, an event represents an access or exposure to a media item by an audience member and a duration for which that audience member accessed or was exposed to that media. In some examples, an event can include an audience member using a device type and a duration for which that audience member used that device type. An audience size is a number of deduplicated or unique audience members that accessed or were exposed to a media item of interest of audience metrics analysis. A deduplicated or unique audience member is one that is counted only once as part of an audience size. Thus, regardless of whether a particular person is detected as accessing a media item once or multiple times, that person is only counted once as the audience size for that media item. In this manner, impression performance for particular media is not disproportionately represented when a small subset of one or more audience members is exposed to or accesses the same media an excessively large number of times while a larger number of audience members is exposed to or accesses that same media fewer times or not at all. Audience size may also be referred to as unique audience or deduplicated audience. By tracking media exposures or accesses by unique audience members, a unique audience measure may be used to determine a reach measure to identify how many unique audience members are reached by media. In some examples, increasing unique audience and, thus, reach, is useful for advertisers wishing to reach a larger audience base.

Notably, although third-party cookies are useful for third-party measurement entities in many of the above-described techniques to track media accesses and to leverage demographic information from third-party database proprietors, use of third-party cookies may be limited or may cease in some or all online markets. That is, use of third-party cookies enables sharing anonymous subscriber information (without revealing personally identifiable information (PII) across entities which can be used to identify and deduplicate audience members across database proprietor impression data, However, to reduce or eliminate the possibility of revealing user identities outside database proprietors by such anonymous data sharing across entities, some websites, internet domains, and/or web browsers will stop (or have already stopped) supporting third-party cookies. This will make it more challenging for third-party measurement entities to track media accesses via first-party servers. That is, although first-party cookies will still be supported and useful for media providers to track accesses to media via their own first-party servers, neutral third parties interested in generating neutral, unbiased audience metrics data will not have access to the impression data collected by the first-party servers using first-party cookies. Examples disclosed herein may be implemented with or without the availability of third-party cookies because, as mentioned above, the datasets used in the deduplication process are generated and provided by database proprietors, which may employ first-party cookies to track media impressions from which the datasets are generated.

As described above, AMEs previously used third-party cookies to determine the demographic distribution of aggregate census-level event data. However, because use of third-party cookies may be limited or may be unavailable in some or all online markets, an alternative approach for estimating census-level data across multiple dimensions and demographics based on database proprietor data is useful. Examples disclosed herein estimate census-level unique audience sizes and event durations across multiple dimensions and demographics based on complete panel data and/or complete database proprietor data. The panel and/or database proprietor data may include aggregate database proprietor audience sizes and panel and/or database proprietor duration data for each dimension across each demographic.

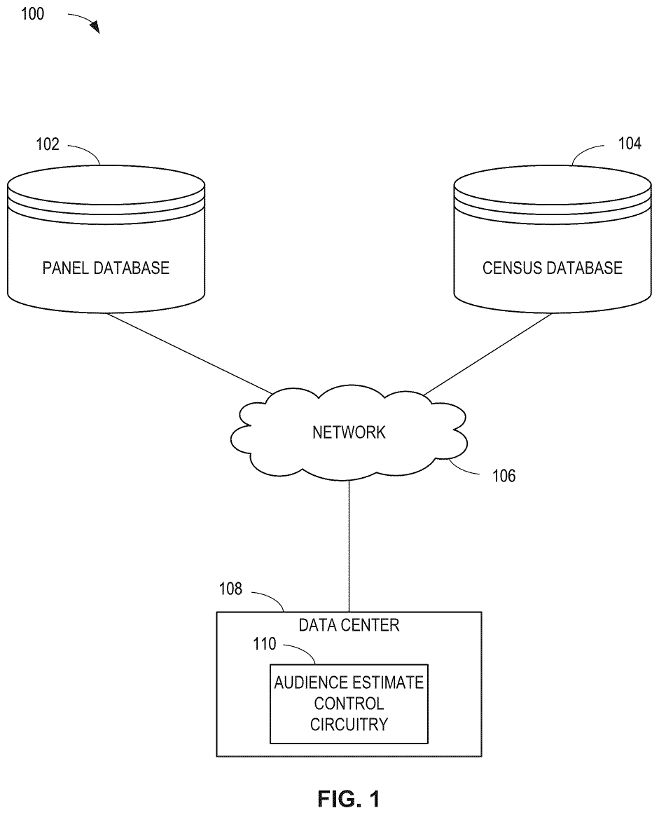

FIG. 1 illustrates an example audience estimation system 100 for estimating census audience size in accordance with teachings of this disclosure. The example audience estimation system 100 includes an example panel database 102, an example census database 104, an example network 106, and an example data center 108. The example data center 108 includes example audience estimate control circuitry 110 to estimate audience sizes and/or durations for media accesses in accordance with teachings of this disclosure. The example data center 108 may be owned and/or operated by an AME, a database proprietor, a media provider, etc.

Examples disclosed herein may be used to monitor for media impressions of any one or more media types (e.g., video, audio, a webpage, an image, text, etc.). In examples disclosed herein, media may be content and/or advertisements. Media may include advertising and/or content delivered via websites, streaming video, streaming audio, Internet protocol television (IPTV), movies, television, radio and/or any other vehicle for delivering media. In some examples, media includes user-generated media that is, for example, uploaded to media upload sites, such as YouTube, and subsequently downloaded and/or streamed by one or more other client devices for playback. Media may also include advertisements. Advertisements are typically distributed with content (e.g., programming, on-demand video and; or audio). Traditionally, content is provided at little or no cost to the audience because it is subsidized by advertisers that pay to have their advertisements distributed with the content. As used herein, “media” refers collectively and; or individually to content and/or advertisement(s). Examples disclosed herein are not restricted for use with any particular type of media. On the contrary, examples disclosed herein may be implemented in connection with tracking impressions for media of any type or form.

In the illustrated example of FIG. 1, the panel database 102 stores panelist data obtained by an AME using panel meters located at panelist households or other panelist metering sites. For example, the panelist data can include monitoring data representative of media accessed by a panelist. A panelist is a person that has enrolled in an audience panel of an entity such as an AME, a database proprietor, and/or any other entity. The person enrolls in the panel by providing PII (e.g., name, demographics, address, etc.) and agreeing to have their media access activities monitored. The example panel database 102 stores panel data including panel audience sizes and/or panel durations (e.g., panel event durations). As used herein, a panel audience size represents a quantity of unique panelist audience members that accessed and/or were exposed to a media item, and a panel duration is a total duration of the exposure or access to that media item by the unique panelist audience members. In some examples, the panel database 102 stores panel data for particular events. For example, the panel database 102 stores a panel duration and a panel audience size for a first website, a panel duration and a panel audience size for a second website, etc.

The example census database 104 of the illustrated example of FIG. 1 stores census data obtained by an AME. For example, the census database 104 can include impression-related data collected from devices not identifiable as belonging to panelists. As such, these impressions are referred to as census impressions collected as anonymous impressions for which a collecting entity (e.g., an AME, a database proprietor, etc.) does not have demographic information. In some examples, the data stored in the census database 104 includes data from a relatively larger sample size compared to the panel data stored in the panel database 102. In examples disclosed herein, the census database 104 stores census durations (e.g., census event durations). As used herein, a census duration is a total duration of exposures or accesses to a media item by corresponding census audience members. In some examples, the census database 104 stores census durations for different events. For example, the census database 104 stores a census duration for a first website, a census duration for a second website, etc.

The example network 106 of the illustrated example of FIG. 1 is a wide area network (WAN) such as the Internet. However, in some examples, local networks may additionally or alternatively be used. Moreover, the example network 106 may be implemented using any type of public or private network, such as, but not limited to, the Internet, a telephone network, a local area network (LAN), a cable network, and/or a wireless network, or any combination thereof.

In the illustrated example of FIG. 1, the data center 108 communicates with the panel database 102 and the census database 104 through the network 106. In some examples, the data center 108 contains the audience estimate control circuitry 110. In the illustrated example of FIG. 1, the data center 108 is an execution environment used to implement the audience estimate control circuitry 110. In some examples, the data center 108 is associated with a media monitoring entity (e.g., an AME, etc.). In some examples, the data center 108 can be a physical processing center (e.g., a central facility of the media monitoring entity, etc.). Additionally or alternatively, the data center 108 can be implemented via a cloud service (e.g., Amazon® Web Services (AWS), Microsoft® Azure Web Services, etc.). In this example, the data center 108 can further store and process panel data and census data.

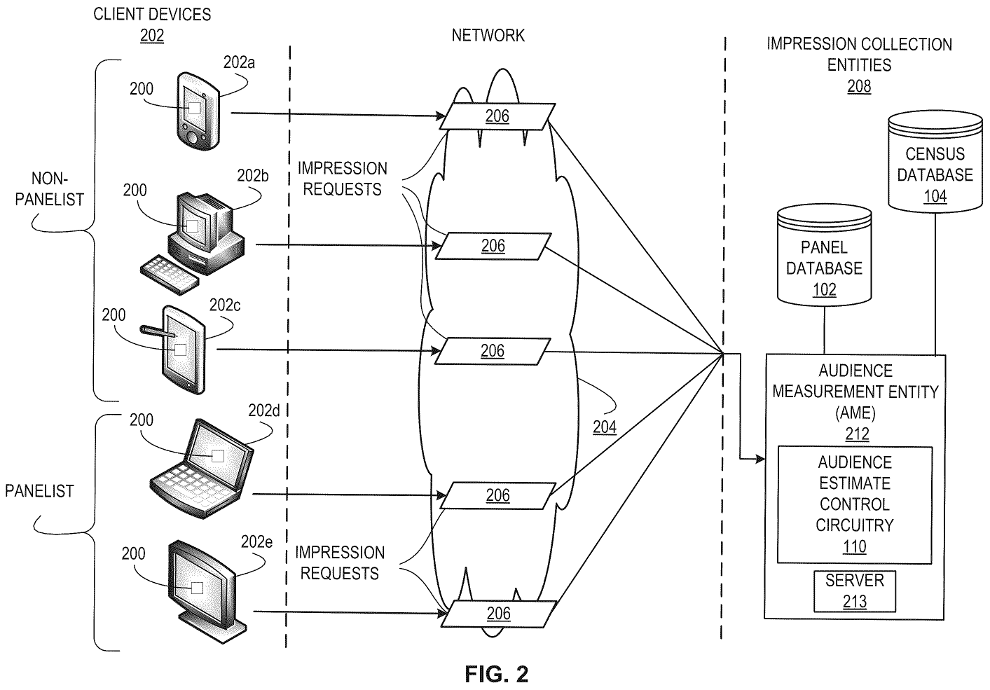

The example audience estimate control circuitry 110 of the illustrated example of FIG. 1 estimates census audience sizes of events. In some examples, the audience estimate control circuitry 110 accesses and obtains panel data (e.g., panel event durations, panel audience sizes) from the panel database 102 and/or census data (e.g., census event durations) from the census database 104. The example audience estimate control circuitry 110 determines a deduplicated census audience size (e.g., a census unique audience size) based on the panel data and the census data. The example audience estimate control circuitry 110 is described below in connection with FIG. 2. In some examples, the audience estimate control circuitry 110 is an application-specific integrated circuit (SIC), and in some examples the audience estimate control circuitry 110 is a field programmable gate array (FPGA). Alternatively or additionally, the example audience estimate control circuitry 110 can be implemented using software and/or firmware executed at the data center 108.

FIG. 2 illustrates example network-based impression logging techniques. Such example techniques may be used to collect the panel impression information (e.g., panel impression records) in the panel database 102 and the census impression information (e.g., panel impression records) in the census database 104. FIG. 2 illustrates example client devices 202 that report audience impression requests for Internet-based media 200 to impression collection entities 208 to identify a unique audience and/or a frequency distribution for the Internet-based media 200. The illustrated example of FIG. 2 includes the example client devices 202, an example network 204, example impression requests 206, and the example impression collection entities 208. As used herein, an impression collection entity 208 refers to any entity that collects impression data (e.g., logs impression records) such as, for example, an example AME 212. Although only the AME 212 is shown, other impression collection entities may also collect impression data. In the illustrated example, the AME 212 logs panel impressions in impression records in the panel database 102 and logs census impressions in impression records in the census database 104. In other examples, one or more other impression collection entities in addition to or instead of the AME 212 may log impressions and/or durations for one or both of the panel database 102 and the census database 104. In some examples, a server 213 of the AME 212 logs census impressions in the census database 104 and another server of a database proprietor (separate from the AME 212) logs panel impressions in the panel database 102 based on its subscribers. In such examples, subscribers of the database proprietor operate the panelist client devices 202d and 202e such that the database proprietor recognizes the panelist client devices 202d, 202e as operated by its subscribers based on information (e.g., first-party cookies) in the impression requests 206 from the panelist client devices 202d, 202e. In the illustrated example, the AME 212 includes the example audience estimate control circuitry 110 of FIG. 1.

The example client devices 202 of the illustrated example may be any device capable of accessing media over a network (e.g., the example network 204). For example, the client devices 202 may be an example mobile device 202a, an example computer 202b, 202d, an example tablet 202c, an example smart television 202e, and/or any other internet-capable device or appliance. Examples disclosed herein may be used to collect impression information for any type of media including content and/or advertisements.

The example network 204 is a communications network. The example network 204 allows transmission or delivery of the example impression requests 206 from the example client devices 202 to the example impression collection entities 208. The example network 204 may be a local area network, a wide area network, the Internet, a cloud, or any other type of communications network.

The impression requests 206 of the illustrated example include information about accesses to media 200 at the corresponding client devices 202 generating the impression requests 206. Such impression requests 206 allow monitoring entities, such as the impression collection entities 208, to collect a number of and/or duration of media impressions for different media 200 accessed via the client devices 202. By collecting media impressions, the impression collection entities 208 can generate media impression quantities for different media 200 (e.g., different content and/or advertisement campaigns).

The impression collection entities 208 of the illustrated example include the example panel database 102, the example census database 104, and the example AME 212. In some examples, execution of the beacon instructions corresponding to the media 200 causes the client devices 202 to send impression requests 206 to the server 213 (e.g., accessible via an Internet protocol (IP) address or uniform resource locator (URL)) of the impression collection entities 208 in the impression requests 206. In some examples, the beacon instructions cause the client devices 202 to provide device and/or user identifiers and media identifiers in the impression requests 206. The device/user identifier may be any identifier used to associate demographic information with a user or users of the client devices 202. Example device/user identifiers include cookies, hardware identifiers (e.g., an international mobile equipment identity (IMEI), a mobile equipment identifier (MEID), a media access control (MAC) address, etc.), an app store identifier (e.g., a Google Android ID, an Apple ID, an Amazon ID, etc.), an open source unique device identifier (OpenUDID), an open device identification number (ODIN), a login identifier (e.g., a username), an email address, user agent data (e.g., application type, operating system, software vendor, software revision, etc), an Ad ID (e.g., an advertising ID introduced by Apple, Inc. for uniquely identifying mobile devices for purposes of serving advertising to such mobile devices), third-party service identifiers (e.g., advertising service identifiers, device usage analytics service identifiers, demographics collection service identifiers), etc. In some examples, fewer or more device/user identifier(s) may be used, The media identifiers (e.g., embedded identifiers, embedded codes, embedded information, signatures, etc.) enable the impression collection entities 208 to identify media (e.g., the media 200) objects accessed via the client devices 202. The impression requests 206 of the illustrated example cause the AME 212 to log impressions for the media 200. In the illustrated example, an impression request is a reporting to the AME 212 of an occurrence of the media 200 being presented at the client device 202. The impression requests 206 may be implemented as a hypertext transfer protocol (HTTP) request. However, whereas a transmitted HTTP request identifies a webpage or other resource to be downloaded, the impression requests 206 include audience measurement information (e.g., media identifiers and device/user identifier) as its payload. The example server 213 to which the impression requests 206 are directed is programmed to log the audience measurement information of the impression requests 206 as an impression (e.g., a media impression such as advertisement and; or content impressions depending on the nature of the media accessed via the client device 202). In some examples, the server 213 of the AME 212 may transmit a response based on receiving an impression request 206. However, a response to the impression request 206 is not necessary. It is sufficient for the server 213 to receive the impression request 206 to log an impression based on the impression request 206. As such, in examples disclosed herein, the impression request 206 is a dummy HTTP request for the purpose of reporting an impression but to which a receiving server need not respond to the originating client device 202 of the impression request 206.

In the illustrated example, the example AME 212 does not provide the media 200 to the client devices 202 and is a trusted (e.g., neutral) third party (e.g., The Nielsen Company, LLC) for providing accurate media access (e.g., exposure) statistics. The example AME 212 includes the example audience estimate control circuitry 110. As further disclosed herein, the example audience estimate control circuitry 110 estimates census audience sizes of events related to the example impression requests 206. The example audience estimate control circuitry 110 is described in connection with FIGS. 1 and/or 3.

In operation, the example client devices 202 employ web browsers and/or applications (e.g., apps) to access media. Some of the web browsers, applications, and/or media include instructions that cause the example client devices 202 to report media monitoring information to one or more of the example impression collection entities 208. That is, when the client device 202 of the illustrated example accesses media, a web browser and/or application of the client device 202 executes instructions in the media, in the web browser, and/or in the application to send the example impression request 206 to one or more of the example impression collection entities 208 via the network (e.g., a local area network, wide area network, wireless network, cellular network, the Internet, and/or any other type of network). The example impression requests 206 of the illustrated example include information about accesses to the media 200 and/or any other media at the corresponding client devices 202 generating the impression requests 206. Such impression requests allow monitoring entities, such as the example impression collection entities 208, to collect media impressions for different media 200 accessed via the example client devices 202. In this manner, the impression collection entities 208 can generate media impression quantities for different media 200 (e.g., different content and/or advertisement campaigns).

The example AME 212 accesses panel data in the example panel database 102 and/or census data in the example census database 104, The panel data includes information related to a total number of the logged impressions and/or any other information related to the logged impressions (e.g., durations, demographics, a total number of registered users exposed to the media 200 more than once, etc.) that corresponds to registered panelists. The census data includes information related to logged impressions and/or any other impression-related information that corresponds to non-panelist audience members. The example audience estimate control circuitry 110 estimates census audience sizes of events based on impression requests 206 in accordance with teachings of this disclosure.

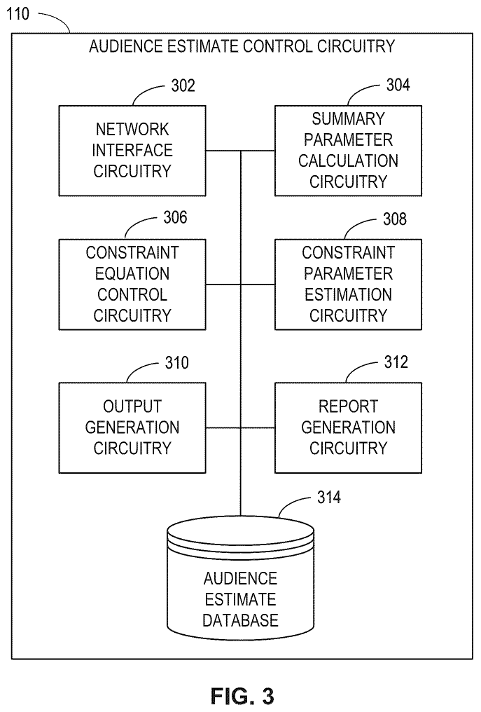

FIG. 3 is a block diagram of the example audience estimate control circuitry 110 of FIGS. 1 and/or 2 to estimate audience sizes and durations across dimensions and demographics. The audience estimate control circuitry 110 of FIG. 3 may be instantiated (e.g., creating an instance of, bring into being for any length of time, materialize, implement, etc.) by processor circuitry such as a central processing unit executing instructions. Additionally or alternatively, the audience estimate control circuitry 110 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 3 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by microprocessor circuitry executing instructions to implement one or more virtual machines and/or containers.

In the illustrated example of FIG. 3, the audience estimate control circuitry 110 includes example network interface circuitry 302, example summary parameter calculation circuitry 304, example constraint equation control circuitry 306, example constraint parameter estimation circuitry 308, example output generation circuitry 310, example report generation circuitry 312, and an example audience estimate database 314.

The example network interface circuitry 302 of the illustrated example of FIG. 3 allows the audience estimate control circuitry 110 to receive and/or otherwise obtain panel data and/or census data from the example network 106 of FIG. 1. In some examples, the network interface circuitry 302 can be continuously connected to the network 106, the panel database 102, and/or the census database 104 for communication with the network 106, the panel database 102, and/or the census database 104. In other examples, the network interface circuitry 302 can be periodically or aperiodically connected for periodic or aperiodic communication with the network 106, the panel database 102, and/or the census database 104. In some examples, the network interface circuitry 302 can be absent.

In examples disclosed herein, the panel data includes panel audience sizes and/or panel impression durations for multiple dimensions (e.g., all dimensions of interest) across multiple demographics (e.g., all demographics of interest). As used herein, a dimension is a subgroup of a larger group. For example, a dimension may include a website from a group of websites, a portion (e.g., a 15-minute portion) of media (e.g., a one-hour show), an episode of a series, one or more stores from a group of stores, etc. In some examples, a an event represents an access to a particular dimension (e.g., an access to particular media, a visit to a particular store, etc.). In some examples, the network interface circuitry 302 may only have access to partial census data (e.g., a total census-level impression count for a single dimension across all demographics or a total census-level impression count for all dimensions across all demographics).

Across n dimensions (e.g., events), an individual can be exposed to any combination of media any number of times for any duration. In some examples, an impression is counted for a particular one of the dimensions when at least one time unit (e.g., 1 second) of duration is observed, Below example Table 1 illustrates panel data and partial census data across n dimensions for a single demographic.

TABLE 1
Demographic index k, population = U₍ₖ₎

| | Panel | | Census | |
|---|---|---|---|---|
| Dim. | Audience | Duration | Audience | Duration |
| l | A_{(1, k)} | D_{(1, k)} | X_{(1, k)} | V_{(1, k)} |
| . . . | . . . | . . . | . . . | . . . |
| j | A_{(j, k)} | D_{(j, k)} | X_{(j, k)} | V_{(j, k)} |
| . . . | . . . | . .. | . . . | . . . |
| n | A_{(n, k)} | D_{(n, k)} | X_{(n, k)} | V_{(n, k)} |
| Total | A_{(•, k)} | D_{(•, k)} | X_{(•, 1)} | V_{(•, k)} |

In the above example Table 1, the variable A represents audience of a panel and the variable D represents durations of the panel for different dimensions j and for demographic k. The variable X represents audience of the census and the variable V represents durations of the census for the different dimensions j and for demographic k. Further, the subscripts of the variables {A, D, X, V} represent the corresponding one of the dimensions j and the corresponding demographic k.

In the example Table 1 a dot (e.g., a bullet) represents a summation and/or aggregation of values across an index. For example, A_{(•, k)} represents a total panel audience size across the j dimensions, and D_{(•,k)} represents a total panel duration aggregated across the j dimensions. Further, X_{(•,k)} represents a total census audience size across the j dimensions, and V_{(•,k)}, represents a total census duration aggregated across the j dimensions. While the total panel duration and the total census duration are calculated by adding corresponding durations across the j dimensions, the total panel audience size and the total census audience size is not the sum of the individual respective audience sizes across the j dimensions because an audience member may be represented in more than one dimension. Instead, the total panel audience size and the total census audience size represent deduplicated audience size totals for the panel and census, respectively. In other words, each audience member is only counted once in the total panel audience size and/or the total census audience size. In some examples, the aggregated panel data (e.g., the total panel audience size A_{(•,k)} and the total panel duration D_{(•,k)}) is determined based on example Equations 1a and 1b below:

$${max}_{j} ( {A}_{( j , k )} ) \leq {A}_{( , k )} \leq {\sum }_{j = 1}^{n} {A}_{( j , k )} \qquad ( Equation 1 A )$$

$${D}_{( , k )} = {\sum }_{j = 1}^{n} {D}_{( j , k )} \qquad ( Equation 1 B )$$

In example Equation 1A above, the total panel audience size A_{(•,k)} (e.g., the deduplicated total panel audience) is greater than or equal to a maximum of the individual panel audience sizes A_{(j,k)}

$$( e . g . , {max}_{j} ( {A}_{( j , k )} ) )$$

but no greater than a sum of the individual panel audience sizes across the n dimensions (e.g., Σⱼ₌₁ⁿA_{(j,k)}). Further, in example Equation 1B above, the total panel duration (e.g., D_{(•,k)}) corresponds to a sum of the individual panel durations across the n dimensions (e.g., Σⱼ₌₁ⁿD_{(j,k)}). In some examples, example Equations 1A and 1B above can be rewritten for determining aggregated census data by replacing panel variables A and D with the corresponding census variables X and V, respectively.

In some examples, the panel data and/or the census data can be distributed across multiple demographics. In some examples, the demographics may correspond to age, gender, geographic area. etc. Example Tables 2 and 3 below represents example panel data and example census data with respect to two dimensions (e.g., =2) and two demographics (e.g., K=2).

TABLE 2
Demographic index k = 1, population = U₍₁₎

| | Panel | | Census | |
|---|---|---|---|---|
| Dim. | Audience | Duration | Audience | Duration |
| 1 | A_{(1, 1)} | D_{(1, 1)} | X_{(1, 1)} | V_{(1, 1)} |
| 2 | A_{(2, 1)} | D_{(2, 1)} | X_{(2, 1)} | V_{(2, 1)} |
| Total | A_{(•, 1)} | | X_{(•, 1)} | |

TABLE 3
Demographic index k = 2, population = U₍₂₎

| | Panel | | Census | |
|---|---|---|---|---|
| Dim. | Audience | Duration | Audience | Duration |
| 1 | A_{(1, 2)} | D_{(1, 2)} | X_{(1, 2)} | V_{(1, 2)} |
| 2 | A_{(2, 2)} | D_{(2, 2)} | X_{(2, 2)} | V_{(2, 2)} |
| Total | A_{(•, 2)} | | X_{(•, 2)} | |

In the example Tables 2 and 3 above, the subscripts for each variable {A, D, X, V} represent corresponding ones of the dimensions j and corresponding ones of the demographics k. For example, D_{(2,1)} represents a panel duration corresponding to the second dimension j=2 and the first demographic k=1. Example Table 4 below represents aggregated panel data and aggregated census data corresponding to Tables 2 and 3.

TABLE 4
Totals Across Demographics

| | Panel | | Census | |
|---|---|---|---|---|
| Dim, | Audience | Duration | Audience | Duration |
| 1 | A_{(1, •)} | D_{(1, •)} | X_{(1, •)} | V_{(1, •)} |
| 2 | A_{(2, •)} | D_{(2, •)} | X_{(2, •)} | V_{(2, •)} |
| Total | A_{(•, •)} | | X_{(•, •)} | V_{(•, •)} |

In example Table 4 above, V_{(1,•)} represents the total census duration for the first dimension j=1 across multiple (e.g., all) K demographics and V_{(2,•)} represents the total census duration for the second. dimension j=2 across multiple (e.g., all) K demographics, such that the total census duration for a particular dimension j across the multiple (e.g., all) K demographics may be generalized as V_{(j,•)}. Further, in example Table 4 above, V_{(•,•)} represents the total aggregate census duration across multiple (e.g., all) n dimensions and multiple (e.g., all) K demographics. Example Equations 2A and 2B below are used to determine V_{(j,.)} and V_{(•,•)}, respectively.

V_{(j,•)}=Σₖ₌₁^{K}V_{(j,k)} (Equation 2A)

V_{(•,•)}=Σₖ₌₁^{K}V_{(•,k)}=Σⱼ₌₁ⁿV_{(j,•)}=Σⱼ₌₁ⁿΣₖ₌₁^{K}V_{(j,k)} (Equation 2B)

In example Equation 2A above, V_{(j,•)} is determined by summing individual ones of the census durations across multiple (e.g., all) K demographics for a particular dimension j. In example Equation 2B above, V_{(•,•)} is determined by summing individual ones of the census durations across multiple (e.g., all) K demographics and across multiple (e.g., all) n dimensions, and can be represented equivalently as summing across either dot notation totals (e.g., V_{(•,k)} or V_{(j,•)} or double summing across multiple (e.g., all) dimensions and demographics. In some examples, example Equations 2A and 2B above can be rewritten for determining aggregated panel data by replacing census variable V with the corresponding panel variable D.

Further, in example Table 4 above, A_{(1,•)} represents the total panel audience size for the first dimension j=1 across multiple (e.g., all) K demographics and A_{(2,•)} a represents the total panel audience size for the second dimension j=2 across multiple (e.g., all) K demographics, such that the total panel audience size for a particular dimension j=1 across multiple (e.g., all) K demographics may be generalized as A_{(j,•)}. In example Table 4 above, A_{(•,•)} represents the total aggregate panel audience size across the n dimensions and. the K demographics. Example Equations 3A and 3B below are used to determine V_{(j,•)} and V_{(•,•)}respectively.

A_{(j,•)}=Σₖ₌₁^{K}A_{(j,k)} (Equation 3a)

A_{(•,•)}=Σₖ₌₁^{K}A_{(•,k)}≤Σⱼ₌₁ⁿA_{(j,•)}=Σⱼ₌₁ⁿΣₖ₌₁^{K}A_{(j,k)} (Equation 3b)

In example Equation 3A above, A_{(j,•)} is determined by summing individual ones of the panel audience sizes across multiple (e.g., K demographics for a particular dimension j. In example Equation 3B above, A_{(•,•)} is determined by summing individual ones of the census durations across multiple (e.g., all) K demographics and across multiple (e.g., all) n dimensions. In some examples, example Equations 3A and 3B above can be rewritten for determining aggregated census data by replacing panel variable A with the corresponding census variable X.

In example Tables 2 and 3 above, U₍₁₎ and U₍₂₎ represent the universe estimate (e.g., population estimate) for the first and second demographics, respectively, As used herein, the universe estimate represents the universe of possible audience members corresponding to a particular demographic.

In examples disclosed herein, all panel information in example Tables 2, 3, and 4 above is known to the audience estimate control circuitry 110, while only partial census information (e.g., the total aggregate census duration V_{(j,•)} for each dimension j and/or the total aggregate census duration V_{(•,•)}) is known. In particular, in the illustrated example of FIG. 3, the network interface circuitry 302 obtains, from the panel database 102 of FIG. 1, the universe estimates U₍ₖ₎, the individual panel audience sizes A_{(j,k)}, and the individual panel durations D_{(j,k)} for the n dimensions and the K demographics. The network interface circuitry 302 also obtains the aggregate panel values (e.g., A_{(•,k)}, A_{(j,•)}, A_{(•,•)}) from the panel database 102, and/or determines the aggregate panel values based on the panel audience sizes and/or panel durations. In some examples, the network interface circuitry 302 obtains the at least one of the total aggregate census duration V_{(j,•)} for each dimension j and/or the total aggregate census duration V_{(•,•)} from the census database 104 of FIG. 1.

The example summary parameter calculation circuitry 304 of the illustrated example of FIG. 3 determines values for summary parameters corresponding to the panel data and/or the census data. In some examples, the summary parameters are constant across the panel data and the census data, and are utilized by the audience estimate control circuitry 110 to solve a maximum entropy problem to determine values for unknown census data (e.g., the census audience sizes and/or the census durations). In some examples, the summary parameters for a maximum entropy problem for a single demographic case can be determined based on example Equations 4A, 4B, 4C, and 4D below.

$$\begin{matrix}{z}_{j}^{( a )} = \frac{{A}_{j}^{2}}{( Q - {A}_{j} ) ( {D}_{j} )} & j = \{ 1 , 2 , … , n \}\end{matrix} \qquad ( Equation 4 A )$$

$$\begin{matrix}{z}_{j}^{( d )} = exp ( - \frac{{A}_{j}}{{D}_{j}} ) & j = \{ 1 , 2 , … , n \}\end{matrix} \qquad ( Equation 4 B )$$

$$\begin{matrix}{z}_{} = \frac{Q - {A}_{}}{U - {A}_{}} & j = \{ 1 , 2 , … , n \}\end{matrix} \qquad ( Equation 4 C )$$

$${z}_{0} = U - {A}_{} \qquad ( Equation 4 D )$$

In example Equations 4A, 4B, 4C, and 4D above, U is the universe of audience members for the single demographic, and z represents the exponents of the Lagrange multipliers of the output for a constrained maximum entropy problem. In the above equations, variable Q represents the pseudo universe estimate of the single demographic. The pseudo universe estimate corresponds to what the size of the universe of audience members would need to be to predict the panel data and the census data assuming independence of the different demographics and/or dimensions. The pseudo universe estimate Q can be determined for a single demographic case using example Equation 5 below.

$$1 - \frac{{A}_{}}{Q} = {\prod }_{j = 1}^{n} = ( 1 - \frac{{A}_{j}}{Q} ) \qquad ( Equation 5 )$$

In examples disclosed herein, multiple demographics and multiple dimensions are considered. In such examples, each of the K demographics includes a corresponding solution. Further, for each of the solutions, two different Q (e.g., one for the panel data and one for the census data) are determined. In examples disclosed herein, variables include superscripts (e.g., {(a), (d)}) to indicate audience and duration labels, and/or a double subscript (encased in parentheses) to indicate a corresponding dimension and demographic.

For the multiple demographics and multiple dimensions case (e.g., with dimensions j={1, 2, . . . , n} and demographics k={1, 2, . . . , K}). the example Equations 4A, 4B, 4C, and 4D above can be represented for the multiple demographic case as shown in example Equations 6A, 6B, 6C, and 6D below.

$$\begin{matrix}{z}_{( j , k )}^{\{ a \}} = \frac{{( {A}_{( j , k )} )}^{2}}{( {Q}_{( k )}^{\{ A \}} - {A}_{( j , k )} ) ( {D}_{( j , k )} )} & j = \{ 1 , 2 , … , n \}\end{matrix} \qquad ( Equation 6 A )$$

$$\begin{matrix}{z}_{( j , k )}^{\{ d \}} = exp ( - \frac{{A}_{( j , k )}}{{D}_{( j , k )}} ) & j = \{ 1 , 2 , … , n \}\end{matrix} \qquad ( Equation 6 B )$$

$$\begin{matrix}{z}_{( k )}^{\{ \}} = \frac{{Q}_{( k )}^{\{ A \}} - {A}_{( , k )}}{{U}_{\{ k \}} - {A}_{( , k )}} & j = \{ 1 , 2 , … , n \}\end{matrix} \qquad ( Equation 6 C )$$

$${z}_{( k )}^{\{ 0 \}} = {U}_{( k )} - {A}_{( , k )} \qquad ( Equation 6 D )$$

In the above example Equations 6A, 6B, 6C, and 6D, Q₍ₖ₎^{{A}} is the panel pseudo universe estimate for demographic k, defined using example Equation 7 below.

$$1 - \frac{{A}_{( , k )}}{{Q}_{( k )}^{\{ A \}}} = {\prod }_{j = 1}^{n} ( 1 - \frac{{A}_{( j , k )}}{{Q}_{( k )}^{\{ A \}}} ) \qquad ( Equation 7 )$$

Some previous solutions to determine census-level data consider individual viewership for respective individuals, where the individual viewership includes combinations of media (e.g., media accessed by the respective individuals) and durations (e.g., durations for which the respective individuals accessed the media). Such previous solutions require sufficient memory (e.g., computer memory) to store the combinations of media and duration for respective individuals.

Alternatively, examples disclosed herein represent aggregate viewership across multiple demographics and multiple dimensions using a maximum entropy probability distribution. For example, example Equations 6A, 6B, 6C, and 6D above correspond to a se of sufficient statistics that can be used to represent the maximum entropy probability distribution for multiple demographics and multiple dimensions. By representing and/or storing census-level data as a maximum entropy probability distribution, examples disclosed herein utilize less memory (e.g., computer memory) compared to previous solutions that require storing the combinations of media and duration for respective individuals.

For example, although durations are continuous and can be multiple (e.g., any) numbers, the durations can be considered discrete on a 1 to 60-second interval. Thus, for five videos across the 1 to 60-second interval, a number of combinations of viewership (e.g., combinations of media and duration) for an individual is 60⁵ (e.g., over 777 million combinations). Some previous solutions require storing the 60⁵ combinations in memory (e.g., computer memory). However, by using the maximum entropy probability distribution in accordance with teachings of this disclosure, a distribution can be expressed using the set of sufficient statistics represented in example Equations 6A, 6B, 6C, and 6D above for multiple demographics (or example Equations 4A, 4B, 4C, and 4D above for a single demographic). By changing individual viewership to aggregate viewership, the distribution across the aggregate can be modeled by a solution to a maximum entropy problem. Accordingly, examples disclosed herein do not require storing and/or tracking the 60⁵ combinations of viewership, and the solution to the maximum entropy problem instead models the distribution using the set of sufficient statistics.

In another example, when 1,000 numbers are normally distributed, the 1,000 numbers do not need to be stored in memory (e.g., computer memory). Instead, by using examples disclosed herein, the 1,000 numbers can be represented by a set of sufficient statistics that can be used to reproduce a distribution corresponding to the 1,000 numbers. For example, by using the maximum entropy probability distribution in accordance with teachings of this disclosure, the set of sufficient statistics represented in example Equations 6A, 6B, 6C, and 6D above (or example Equations 4A, 4B, 4C, and 4D above for a single demographic) can be stored in memory (e.g., computer memory) instead of individual records (e.g., the 60⁵ combinations of viewership). Accordingly, examples disclosed herein utilize significantly less memory (e.g., computer memory) by using the maximum entropy probability distribution.

A similar equation can be generated for census audience X, with notational change from Q₍ₖ₎^{{A}} to Q₍ₖ₎^{{X}}. In some examples, an additional notation is used to distinguish one or more variables from the panel to the census. For example, the panel is associated with label Q, and the census is associated with label P. As such, an additional label can be used for the superscript (e.g., z_{(j,k)}^{{a,P}} and z_{(j,k)}^{{a,Q}}.

In the illustrated example of FIG. 3, the summary parameter calculation circuitry 304 calculates the summary parameters {z_{(j,k)}^{a}}, z_{(j,k)}^{{d}}, z₍ₖ₎^{{•}}, z₍ₖ₎^{{0}}, Q₍ₖ₎^{{A}} for the multiple demographic case based on example

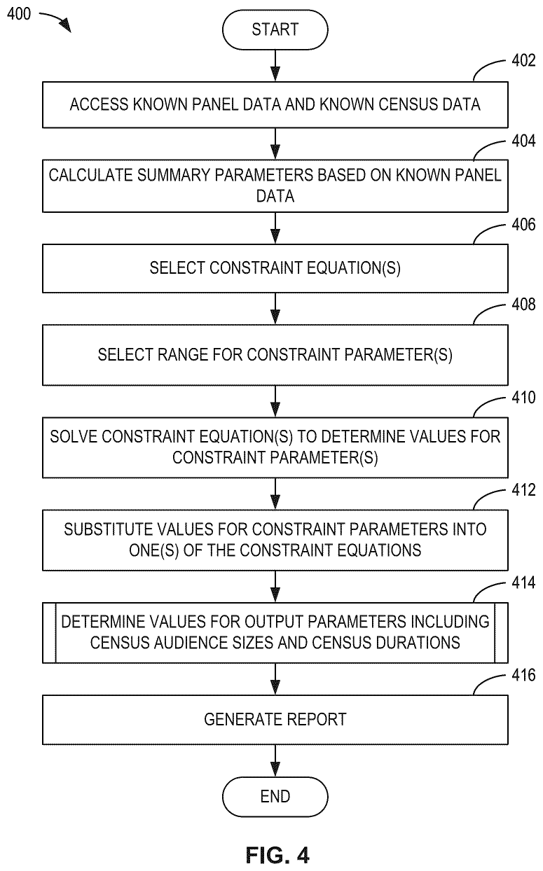

Equations 6A, 6B, 6C, 6D, and 7 above. For example, the summary parameter circuitry 304 substitutes the known panel data {A_{(j,k)}, D_{(j,k)}, A_{(•,k)}, U₍ₖ₎} into Equations 6A, 6B, 6C, 6D, and 7 above to calculate values for the summary parameters. In this example, the summary parameters are the same across the panel and the census. In some examples, the summary parameter calculation circuitry 304 provides the calculated values for the summary parameters to the audience estimate database 314 of FIG. 3 for storage therein. In some examples, the summary parameter calculation circuitry 304 is instantiated by processor circuitry executing summary parameter circuitry instructions and/or configured to perform operations such as those represented by the flowchart of FIG. 4.

The example constraint equation control circuitry 306 of FIG. 3 selects constraint equations based on the panel data, the known census data, and the calculated summary parameters. In some examples, the constraint equations are utilized by the audience estimate control circuitry 110 to determine values for the unknown census durations and/or the unknown census audience sizes.

In some examples, a general solution for any combination of constraints across the audience and/or durations within or across demographics may be difficult to obtain. As such, in examples disclosed herein, the constraint equation control circuitry 306 simplifies the problem of solving for unknown census durations and/or unknown census audience sizes by identifying and solving a simpler problem based on the known census data. For example, while the known census data may include total aggregate census durations for each dimension j, the individual census durations distributed across the K demographics are unknown. In such examples, the constraint equation control circuitry 306 selects constraint equations for the simpler problem by noting that the census durations for a particular dimension j and summed across multiple (e.g., all) K demographics correspond to a known total aggregate census duration for the particular dimension j. In particular, the constraint equation control circuitry 306 selects the constraint equations based on example Equation 8 below, which represents the known relationship between the census durations and the known total aggregate census duration for a particular dimension j.

V_{(j,•)}=Σₖ₌₁^{K}V_{(j,k)}j={1, 2, . . . , n} (Equation 8)

In example Equation 8 above, V_{(j,k)} represents the individual census durations, and V_{(j,•)} represents the total aggregate census duration for a particular dimension j. Further, example Equation 8 above includes n constraints, where each of the n constraints has a corresponding Lagrange multiplier λ₍ⱼ₎^{{V}}. In this example, the superscript of the Lagrange multiplier represents the census variable associated with the constraint, and the subscript represents the numerical index of the corresponding dimension.

For the kth demographic, values for the unknown variables X_{(j,k)}, V_{(j,k)}, and X_{(•,k)} can be determined by solving the below example Equations 9A, 9B, 9C, and 10, where the example Equations 9A, 9B, 9C, and 10 are based on example Equations 6A, 6B, 6C, and 7 above.

$$log ( \frac{{( {X}_{( j , k )} )}^{2}}{( {Q}_{( k )}^{\{ X \}} - {X}_{( j , k )} ) ( {V}_{( j , k )} )} ) - log ( {z}_{( j , k )}^{\{ a , Q \}} ) = 0 \qquad ( Equation 9 A )$$

$$log ( exp - ( \frac{{X}_{( j , k )}}{{V}_{( j , k )}} ) - log ( {z}_{( j , k )}^{\{ d , Q \}} ) = {λ}_{( j )}^{\{ V \}} \qquad ( Equation 9 B )$$

$$log ( \frac{{Q}_{( k )}^{\{ X \}} - {X}_{( , k )}}{{U}_{k} - {X}_{( , k )}} ) - log ( {z}_{k}^{\{ , Q \}} ) = 0 \qquad ( Equation 9 C )$$

$$1 - \frac{{X}_{( , k )}}{{Q}_{( k )}^{\{ X \}}} = {\prod }_{j = 1}^{n} ( 1 - \frac{{X}_{( j , k )}}{{Q}_{( k )}^{\{ X \}}} ) \qquad ( Equation 10 )$$

Although values for the unknown variables can be determined by solving the above example system of Equations 9A, 9B, 9C, and 10 using traditional techniques (e.g., numerical techniques, iterative methods), such traditional techniques require a large amount of processor resources and/or memory. Also, the example system of Equations 9A, 9B, 9C, and 10 does not account for particular constraints, such as the census duration constraint (e.g., V_{(j,•)}=Σₖ₌₁^{K}V_{(j,k)}) represented in Equation 8 above. Accordingly, such traditional techniques may result in errors and/or result in audience estimations that are mathematically correct, but realistically incorrect (e.g., negative values, errors, etc.). Accordingly, examples disclosed herein perform an analytical approach (e.g., using one or more of example Equations 11A-22 below) to solve for unknown values that results in mathematically and realistically correct solutions that require less memory and processor resources than traditional techniques. Further, by simultaneously solving for unknown values across multiple demographics using a single system of equations (e.g., based on example Equations 11-22 below), examples disclosed herein reduce processing time compared to previous methods that require solving for the unknown values for ones of the demographics individually.

To realize the analytical approach, examples disclosed herein define c₍ⱼ₎^{{T}}=λ₍ⱼ₎^{{V}}. Further, an example frequency variable f_{(j,k)}^{{V}} is defined as shown in example Equation 11A below, and an example odds variable o_{(j,k)} is defined as a function of f_{(j,k)}^{{V}} as shown in example Equation 11B below. Accordingly, the solution to X_{(j,k)} can be obtained based on the system of Equations 9A, 9B, 9C, and 10 along with the definitions of f_{(j,k)}^{{V}} and o_{(j,k)} in Equations 11A and 11B, respectively. The solution to X_{(j,k)} is shown in example Equation 11C below.

$${f}_{( j , k )}^{\{ V \}} = - {( {c}_{( j )}^{\{ V \}} + log ( {z}_{( j , k )}^{\{ d , Q \}} ) )}^{- 1} \qquad ( Equation 11 A )$$

$${o}_{( j , k )} = ( {z}_{( j , k )}^{\{ a , Q \}} ) ( {f}_{( j , k )}^{\{ V \}} \qquad ( Equation 11 B )$$

$${X}_{( j , k )} = ( \frac{{o}_{( j , k )}}{1 + {o}_{( j , k )}} ) {Q}_{( k )}^{\{ X \}} \qquad ( Equation 11 C )$$

In the above Equations 11A, 11B, and 11C, f_{(j,k)}^{{V}} represents the frequency of census durations for a corresponding dimension j and demographic k, and o_{(j,k)} represents the odds or probability of a person being in a particular census audience corresponding to dimension j and demographic k.

In example Equation 11C above, Q₍ₖ₎^{{X}} represents the pseudo universe estimate corresponding to the census audience for a particular dimension. As shown in example Equation 10 above, Q₍ₖ₎^{{X}} is a function of X_{(j,k)} across the n dimensions and the total deduplicated census audience X_{(•,k)}. Likewise, X_{(•,k)} is a function of Q₍ₖ₎^{{X}} and X_{(j,k)} across the n dimensions. Thus, while the definitions of Q₍ₖ₎^{{X}} and X_{(•,k)} may appear circular and unsolvable, the above system of Equations 9A, 9B, 9C, and 10 can be solved by identifying two additional equations that are true. The first equation is obtained from the definition of Q₍ₖ₎^{{X}} (e.g., shown in example Equation 10 above) and the second equation is obtained based on the invariance of z₍ₖ₎^{(•)} (e.g., by rearranging example Equation 9C above). In particular, the additional constraints based on Q₍ₖ₎^{{X}} and X_{(•,k)} are shown below in example Equations 12A and 12B, respectively.

$$1 - \frac{{X}_{( , k )}}{{Q}_{( k )}^{\{ X \}}} = {\prod }_{j = 1}^{n} ( 1 - \frac{{X}_{( j , k )}}{{Q}_{( k )}^{\{ X \}}} ) \qquad ( Equation 12 A )$$

$$\frac{{Q}_{( k )}^{\{ X \}} - {X}_{( , k )}}{{U}_{( k )} - {X}_{( , k )}} = {z}_{( k )}^{\{ , Q \}} \qquad ( Equation 12 B )$$

The definition of Q₍ₖ₎^{{X}} can be rephrased by substituting the definition of X_{(j,k)} from example Equation 11C above into Equation 12A and rearranging as shown in example Equations 13A, 13B, 13C, and 13D below.

$$\begin{matrix}1 - \frac{{X}_{( , k )}}{{Q}_{( k )}^{\{ X \}}} = {\prod }_{j = 1}^{n} ( 1 - \frac{{X}_{( j , k )}}{{Q}_{( k )}^{\{ X \}}} ) ( Equation 13 A ) \\ = {\prod }_{j = 1}^{n} ( 1 - \frac{{o}_{( j , k )}}{1 = {o}_{( j , k )}} ) ( Equation 13 B ) \\ = {\prod }_{j = 1}^{n} ( \frac{1}{( 1 + {o}_{( j , k )} )} ) ( Equation 13 C ) \\ = \frac{1}{{\prod }_{j = 1}^{n} ( 1 + {o}_{( j , k )} )} ( Equation 13 D )\end{matrix}$$

Further, by defining P₍ₖ₎=Πⱼ₌₁ⁿ(1+o_{(j,k)}), example Equations 12A and 12B can be rewritten as shown below in example Equations 14A and 14B, respectively.

$$\frac{{Q}_{( k )}^{\{ X \}}}{{Q}_{( k )}^{\{ X \}} - {X}_{( , k )}} = {P}_{k} \qquad ( Equation 14 A )$$

$$\frac{{Q}_{( k )}^{\{ X \}} - {X}_{( , k )}}{{U}_{k} - {X}_{( , k )}} = {z}_{k}^{\{ , Q \}} \qquad ( Equation 14 B )$$

Both sides of example Equations 14A and 14B are multiplied by the corresponding denominators and rearranged, thus resulting in two linear equations with two unknowns (e.g., X_{(•,k)} and Q₍ₖ₎^{{X}}) as shown in example Equations 15A and 15B below.

$${X}_{( , k )} = ( \frac{( {P}_{k} - 1 ) {z}_{( k )}^{\{ , Q \}}}{1 + ( {P}_{k} - 1 ) {z}_{( k )}^{\{ , Q \}}} ) {U}_{k} \qquad ( Equation 15 A )$$

$${Q}_{( k )}^{{\{ X \}}^{}} = ( \frac{{P}_{k} {z}_{( k )}^{\{ , Q \}}}{1 + ( {P}_{k} - 1 ) {z}_{( k )}^{\{ , Q \}}} ) {U}_{k} \qquad ( Equation 15 B )$$

In some examples, by defining o_{(•,k)}=(P₍ₖ₎−1)z₍ₖ₎^{{•,Q}}, example Equations 15A and 15B can be simplified as shown below in example Equations 16A and 16B, respectively.

$${X}_{( , k )} = ( \frac{{o}_{( , k )}}{1 + {o}_{( , k )}} ) {U}_{( k )} \qquad ( Equation 16 A )$$

$${Q}_{( k )}^{\{ X \}} = ( \frac{{P}_{( k )}}{{P}_{( k )} - 1} ) {X}_{( , k )} \qquad ( Equation 16 B )$$

In some examples, the solutions for X_{(•,k)}and Q₍ₖ₎^{{X}} from Equations 16A and 16B, respectively, can be used to solve for X_{(j,k)} in example Equation 11C above. The solution for X_{(j,k)} can, in turn, be used to determine V_{(j,k)}. Thus, example Equations 11-16 can be used to solve the example system of Equations 9A, 9B, and 9C by solving for the unknown values of X_{(j,k)}, V_{j,k)}, and X_{(•,k)}.

In examples disclosed herein, the constraint equations represented in example Equations 11-16 above can be summarized by the algorithm represented in example Equations 17A-22 below to determine values for the unknown census parameters (e.g., X_{(j,k)}, V_{j,k)}, and X_{(•,k)}) across n dimensions and K demographics. In particular, each of example Equations 17A-22 below can be written as functions of the N unknown constraint parameters c₍ⱼ₎^{{V}}. In this example, the constraint parameters c₍ⱼ₎^{{V}} are indexed by dimension j, but are the same across the K demographics.

In the illustrated example of FIG. 3, the audience estimate control circuitry 110 executes the algorithm represented in example Equations 17A-22 below to determine values for the unknown census parameters. For example, the example constraint equation control circuitry 306 of FIG. 3 selects a system of N constraint equations corresponding to the solution represented in example Equations 17A-22, where the N constraint equations are a function of the N constraint parameters c₍ⱼ₎^{{V}}. Further, the example constraint parameter estimation circuitry 308 of FIG. 3 solves the system of N constraint equations to determine values for the N constraint parameters c₍ⱼ₎^{{V}}. Finally, the example output generation circuitry 310 of FIG. 3 substitutes the determined values for the N constraint parameters c₍ⱼ₎^{{V}}, the known panel data, and the calculated summary parameters into example Equations 17A-22 to determine values for output parameters (e.g., including X_{(j,k)}, V_{(j,k)}, and X_{(•,k)}).

To execute the algorithm of Equations 17A-22, the definition of the frequency variable f_{(j,k)}^{{V}} (e.g., shown in example Equation 11A above and repeated in example Equation 17A below) is rephrased by substituting Equation 6B above into example Equation 17A and rearranging to produce example Equation 17B below.

$$\begin{matrix}{f}_{( j , k )}^{\{ V \}} & = & - {( {c}_{( j )}^{\{ V \}} + log ( {z}_{( j , k )}^{\{ d , Q \}} ) )}^{- 1} & ( Equation 17 A ) \\ & = & {( \frac{{A}_{( j , k )}}{{D}_{( j , k )}} - {c}_{( j )}^{\{ V \}} )}^{- 1} & ( Equation 17 B )\end{matrix}$$

In example Equation 17B above, is a function of the unknown constraint parameters f_{(j,k)}^{{V}} the known panel audience sizes A_{(j,k)}, and the known panel durations D_{(j,k)}. Further, f_{(j,k)}^{{V}} is substituted into the definition of the odds variable o_{(j,k)} in example Equation 17C below (e.g., corresponding to example Equation 11B above), such that o_{(j,k)} is also a function of the unknown constraint parameters c₍ⱼ₎^{{V}} and the calculated summary parameter z_{(j,k)}^{{a,Q}}.

o_{(j,k)}=(z_{(j,k)}^{{a,Q}})(f_{(j,k)}^{{V}} (Equation 17C)

Further, the demographic-level estimates for total unique (e.g., deduplicated) census audience can be estimated based on example Equation 18C below using the definitions of P₍ₖ₎ and o_{(•,k)} shown below in example Equations 18A and 18B, respectively.

$${P}_{( k )} = {\prod }_{j = 1}^{N} ( 1 + {o}_{( j , k )} ) \qquad ( Equation 18 A )$$

$${o}_{( , k )} = ( {P}_{( k )} - 1 ) {z}_{( k )}^{\{ , Q \}} \qquad ( Equation 18 B )$$

$${X}_{( , k )} = ( \frac{{o}_{( , k )}}{1 + {o}_{( , k )}} ) {U}_{( k )} \qquad ( Equation 18 C )$$

In example Equation 18A above, P₍ₖ₎ represents a probability parameter and is a function of o_{(j,k)} and, thus, is a function of the unknown constraint parameters c₍ⱼ₎^{{V}}. Accordingly, in example Equation 18B, o_{(•,k)} represents an aggregate odds parameter and is a function of P₍ₖ₎ and, thus, c₍ⱼ₎^{{V}}. Thus, the demographic-level estimates for total unique census audience (e.g., X_{(•, k)}) for a particular demographic k can be estimated using example Equation 18C above (e.g., corresponding to example Equation 16A above) based on o_{(•,k)} (e.g., a function of c₍ⱼ₎^{{V}} and the known universe estimate U₍ₖ₎ corresponding to the particular demographic k. The values for X_{(•,k)} can be used to determine the pseudo universe estimate (e.g., Q₍ₖ₎^{{X}} for the particular demographic k based on example Equation 19 below (e.g., corresponding to example Equation 16B above).

$${Q}_{( k )}^{\{ X \}} = ( \frac{{P}_{( k )}}{{P}_{( k )} - 1} ) {X}_{( , k )} \qquad ( Equation 19 )$$

After determining the pseudo universe estimates Q₍ₖ₎^{{X}} (e.g., which are a function of c₍ⱼ₎^{{V}}, example Equations 20A and 20B below can be used to determine the census audience sizes X_{(j,k)} and the census durations V_{j,k)} for each dimension j and demographic k.

$${X}_{( j , k )} = ( \frac{{o}_{( , k )}}{1 + {o}_{( , k )}} ) {Q}_{( k )}^{\{ X \}} \qquad ( Equation 20 A )$$

$${V}_{( j , k )} = ( {f}_{( j , k )}^{\{ V \}} ) {X}_{( j , k )} \qquad ( Equation 20 B )$$

In Equations 20A and 20B above, o_{(•,k)}, Q₍ₖ₎^{{X}}, and f_{(j,k)}^{{V}} are functions of the unknown constraint parameters c₍ⱼ₎^{{V}}, such that X_{(j,k)} and V_{(j,k)} are likewise functions of c₍ⱼ₎^{{V}}. In some examples, the values of c₍ⱼ₎^{{V}} for j={1, . . . N} are constrained as shown in example Equation 21 below.

$$- ∞ \leq {c}_{( j )}^{\{ V \}} \leq {min}_{k} ( \frac{{A}_{( j , k )}}{{D}_{( j , k )}} ) \qquad ( Equation 21 )$$

To solve for the unknown values of c₍ⱼ₎^{{V}}, the example constraint equation control circuitry 306 of FIG. 3 selects constraint equations for j={1, . . , N} based on the known relationship between the census durations V_{(j,k)} and the known total aggregate census duration V_{(j,•)} for a particular dimension (e.g., described in connection with Equation 8 above and shown in example Equation 22 below).

Σₖ₌₁^{K}V_{(j,k)}=V_{(j,•)} (Equation 22)

In particular, the constraint equation control circuitry 306 selects a system of constraint equations by selecting example Equation 22 above for each of the constraints indexed by dimension j={1, . . . , N}, resulting in a system of N constraint equations. Furthermore, for each constraint equation in the system of N constraint equations, V_{(j,•)} is known from the known census data and V_{(j,k)} is a function of the constraint parameters c₍ⱼ₎^{{V}}. Thus, the constraint equation control circuitry 306 selects a system of N constraint equations with N unknown constraint parameters c₍ⱼ₎^{{V}}, where the system of N constraint equations can be solved to determine values for the constraint parameters c₍ⱼ₎^{{V}}.

The example constraint parameter estimation circuitry 308 of the illustrated example of FIG. 3 solves the system of N constraint equations to determine values for the N constraint parameters c₍ⱼ₎^{{V}}. For example, the constraint parameter estimation circuitry 308 solves the system of N constraint equations subject to the range of possible values for c₍ⱼ₎^{{V}} as defined in example Equation 21 above. In some examples, the constraint parameter estimation circuitry 308 can use any numerical algorithm for solving the system of N constraint equations to determine c₍ⱼ₎^{{V}}. In some examples, the constraint parameter estimation circuitry 308 provides the values for the N constraint parameters c_{(f)}^{{V}} to the audience estimate database 314 of FIG. 3 for storage therein. In some examples, the constraint parameter estimation circuitry 308 is instantiated by processor circuitry executing constraint parameter estimation circuitry instructions and/or configured to perform operations such as those represented by the flowcharts of FIGS. 4 and/or 6.

The example output generation circuitry 310 of the illustrated example of FIG. 3 solves for output parameters based on the determined constraint parameters (e.g., c₍ⱼ₎^{{V}}), the known panel data (e.g., the panel audience sizes A_{(j,k)}, the panel durations D_{(j,k)}, the aggregate panel audiences per demographic A_{(•,k)}, and the universe estimates U₍ₖ₎), and the calculated summary parameters (e.g., the panel pseudo universe estimate Q₍ₖ₎^{{A}}, and the summary z_{(j,k)}^{{a}}, z_{(j,k)}^{{d}}, zₖ^{{•}, and z}ₖ^{{0}}). In some examples, the output parameters include the census audience sizes X_{(j,k)} and the census durations V_{(j,k)}. In some examples, the output parameters further include intermediate parameters (e.g., intermediate output parameters) including the frequency parameters f_{(j,k)}^{{V}}, the odds parameters o_{(j,k)}, probability parameters P₍ₖ₎, the aggregate odds parameters o_{(•k)}, the aggregate census audience sizes per demographic X_{(•,k)}, and/or the census pseudo universe estimates Q₍ₖ₎^{{X}}. In some examples, the output generation circuitry 310 determines one or more of the output parameters based on the intermediate equations (e.g., corresponding to ones of the example Equations 17A-20B above).

For example, the output generation circuitry 310 determines the frequency parameters f_{(j,k)}^{{V}} based on example Equation 17B above by substituting the panel audience sizes A_{(j,k)}, the panel durations D_{(j,k)}, and the constraint parameters c₍ⱼ₎^{{V}} into the right-hand side of Equation 17B to solve for f_{(j,k)}^{{V}}. In some examples, the output generation circuitry 310 determines the odds parameters o_{(j,k)} based on example Equation 17C above by substituting the frequency parameters f_{(j,k)}^{{V}} and the summary parameter z_{(j,k)}^{{a}} into the right-hand side of Equation 17C to solve for o_{(j,k)}. In some examples, the output generation circuitry 310 determines the probability parameters P₍ₖ₎ based on example Equation 18A above by substituting the odds parameters o_{(j,k)} into the right-hand side of Equation 18A to solve for P₍ₖ₎. In some examples, the output generation circuitry 310 determines the aggregate odds parameters o_{(•,k)} based on example Equation 18B above by substituting the probability parameters P₍ₖ₎ and the summary parameter zₖ^{{•}} into the right-hand side of Equation 18B to solve for o_{(•,k)}. In some examples, the output generation circuitry 310 determines the aggregate census audience sizes per demographic X_{(•,k)} based on example Equation 18C above by substituting the aggregate odds parameters o_{(•,k)} and the universe estimates U₍ₖ₎ into the right-hand side of Equation 18C to solve for X_{(•,k)}. In some examples, the output generation circuitry 310 determines the census pseudo universe estimates Q₍ₖ₎^{{X}} based on example Equation 19 above by substituting the probability parameters P₍ₖ₎ and the aggregate census audience sizes per demographic X_{(•,k)} into the right-hand side of Equation 19 to solve for Q₍ₖ₎^{{X}}.

In some examples, the output generation circuitry 310 determines the census audience sizes and the census durations based on the intermediate parameters. For example, the output generation circuitry 310 determines the census audience sizes X _{j,k)} based on example Equation 20A above by substituting the odds parameters o_{(j,k)} and the census pseudo universe estimates Q₍ₖ₎^{{X}} into the right-hand side of Equation 20A to solve for X_{(j,k)}. Further, the output generation circuitry 310 determines the census durations V_{(j,k)} based on example Equation 20B above by substituting the frequency parameters f_{(j,k)}^{{V}} and the census audience sizes X_{(j,k)} into the right-hand side of Equation 20B to solve for V_{(j,k)}.

In some examples, the output generation circuitry 310 provides calculated and/or selected values for the output parameters to the audience estimate database 314 of FIG. 3 for storage therein. In some examples, the output generation circuitry 310 is instantiated by processor circuitry executing output generation circuitry instructions and/or configured to perform operations such as those represented by the flowcharts of FIG. 4, 5, and or 6.

The example report generation circuitry 312 of the illustrated example of FIG. 3 generates an output including data stored in the example audience estimate database 314. For example, the report generation circuitry 312 generates a report including census audience sizes and/or census durations corresponding to one or more dimensions and/or one or more demographics. In some examples, the report generation circuitry 312 is instantiated by processor circuitry executing report generation circuitry instructions and/or configured to perform operations such as those represented by the flowchart of FIG. 4.

The example audience estimate database 314 of the illustrated example of FIG. 3 stores audience estimate data including at least one of the panel data, the census data, the summary parameters, the constraint parameters, and/or the output parameters. The example audience estimate database 314 is implemented by any memory, storage device and/or storage disc for storing data such as, for example, flash memory, magnetic media, optical media, solid state memory, hard drive(s), thumb drive(s), etc. Furthermore, the data stored in the example audience estimate database 314 may be in any data format such as, for example, binary data, comma delimited data, tab delimited data, structured query language (SQL) structures, etc. While, in the illustrated example, the example audience estimate database 314 is illustrated as a single device, the example audience estimate database 314 and/or any other data storage devices described herein may be implemented by any number and/or type(s) of memories.

A first example of determining unknown census data. when the aggregate census duration per demographic (e.g., V_{(j,•)}) is known is discussed in connection with example Tables 5, 6, and 7A below. In this example, Tables 5, 6, and 7A below illustrate example panel data and example census data corresponding to two dimensions (e.g., j={1,2}, n=2) and two demographics (e.g., k={1,2}, K=2).

TABLE 5
Demographic index k = 1, U₍₁₎ = 1,000

| | Panel | | Census | |
|---|---|---|---|---|
| Dim. | Audience | Duration | Audience | Duration |
| 1 | 100 | 200 | X_{(1, 1)} | V_{(1, 1)} |
| 2 | 200 | 600 | X_{(2, 1)} | V_{(2, 1)} |
| Total | 250 | | X_{(•, 1)} | |

TABLE 6
Demographic index k = 2, U₍₂₎ = 2,000

| | Panel | | Census | |
|---|---|---|---|---|
| Dim. | Audience | Duration | Audience | Duration |
| 1 | 150 | 800 | X_{(1, 2)} | V_{(1, 2)} |
| 2 | 250 | 400 | X_{(2, 2)} | V_{(2, 2)} |
| Total | 300 | | X_{(•, 2)} | |

TABLE 7A
Total Across Demographics

| | Panel | | Census | |
|---|---|---|---|---|
| Dim. | Audience | Duration | Audience | Duration |
| 1 | 250 | 1,000 | X_{(1, •)} | 1,500 |
| 2 | 450 | 1,000 | X_{(2, •)} | 1,300 |
| Total | 550 | | X_{(•, •)} | |

In this example, the known data includes panel audience sizes A_{(j,k)} and panel durations D_{(j,k)} for each dimension j and demographic k combination, the total deduplicated panel audience (e.g., the aggregate panel audience) per demographic A_{(•,k)}, the universe estimates per demographic U₍ₖ₎, and the aggregate census durations per dimension V_{(j, •)}. In some examples, the known data in example Tables 5, 6, and 7A above can be represented in matrix and vector format as shown in example Equations 23A-23E below.

$$A = [ \begin{matrix}100 & 150 \\ 200 & 250\end{matrix} ] \qquad ( Equation 23 A )$$

$$D = [ \begin{matrix}200 & 800 \\ 600 & 400\end{matrix} ] \qquad ( Equation 23 B )$$

$${A}_{( , - )} = [ \begin{matrix}250 & 300\end{matrix} ] \qquad ( Equation 23 C )$$

$$U = [ \begin{matrix}1000 & 2000\end{matrix} ] \qquad ( Equation 23 D )$$

$${V}_{( j , )} = [ \begin{matrix}1500 \\ 1300\end{matrix} ] \qquad ( Equation 23 E )$$

In example Equations 23A-23E above, rows represent the dimensions and columns represent the demographics. In example Equations 23A-23E above, the dash (e.g., —) notation in the variable subscripts represents a free (e.g., open) index and is used to differentiate from the dot (e.g., •) notation representing summation and/or aggregation of values across an index.

In this example, the example summary parameter calculation circuitry 304 calculates the summary parameters (e.g., z_{(j,k)}^{{a}}, z_{(j,k)}^{{d}}, z₍ₖ₎^{{•}}, z₍ₖ₎^{{0}}, Q₍ₖ₎^{{A}}) corresponding to the known data in example Equations 23A-E based on the example Equations 6A-7 above. As a result, the summary parameter calculation circuitry 304 outputs the example summary parameters shown in example Equations 24A-24E below.

$${Q}^{\{ A \}} = [ \begin{matrix}400 & 375\end{matrix} ] \qquad ( Equation 24 A )$$

$${z}^{\{ 0 \}} = [ \begin{matrix}750 & 1700\end{matrix} ] \qquad ( Equation 24 B )$$

$${z}^{\{ \}} = [ \begin{matrix}0.2 & 0.0441176 ]\end{matrix} \qquad ( Equation 24 C )$$

$${z}^{\{ a \}} = [ \begin{matrix}0.166666 & 0.125 \\ 0.333333 & 1.25\end{matrix} ] \qquad ( Equation 24 D )$$

$${z}^{\{ d \}} = [ \begin{matrix}0.606531 & 0.829029 \\ 0.716531 & 0.535261\end{matrix} ] \qquad ( Equation 24 E )$$

In this example, the example constraint equation control circuitry 306 selects example ranges for the unknown constraint parameters c₍₁₎^{{V}}, c₍₂₎^{{V}} based on example Equation 21 above and the panel audience sizes A_{(j,k)} and the panel durations D_{(j,k)}. The resulting ranges are represented in example Equation 25 below.

$$[ \begin{matrix}- ∞ \\ - ∞\end{matrix} ] < [ \begin{matrix}{c}_{( 1 )}^{\{ V \}} \\ {c}_{( 2 )}^{\{ V \}}\end{matrix} ] \leq [ \begin{matrix}0.1875 \\ 0.333333\end{matrix} ] \qquad ( Equation 25 )$$

The example constraint equation control circuitry 306 selects constraint equations based on Equation 22 above and the known census data V_{j,•)} for each dimension j={1,2}, which can be represented generally as shown below in example Equations 26A and 26B.

V_{(1,1)}+V_{(1,2)}=1500 (Equation 26A)

V_{(2,1)}+V_{(2,2)}=1300 (Equation 26B)

In some examples, the constraint equation control circuitry 306 iteratively substitutes example Equations 17A-20B above into the constraint equations of example Equations 26A and 26B above such that the constraint equations are written as functions of the constraint parameters c₍₁₎^{{V}} and c₍₂₎^{{V}}. In other words, the constraint equation control circuitry 306 selects two constraint equations having two unknown constraint parameters. In such examples, the example constraint parameter estimation circuitry 308 solves the two constraint equations (e.g., Equations 26A and 26B above) to determine values for each of the constraint parameters as shown in example Equation 27 below.

$${c}^{\{ V \}} = [ \begin{matrix}0.0361122 \\ 0.0479168\end{matrix} ] \qquad ( Equation 27 )$$

In some examples, the example output generation circuitry 310 can substitute the constraint parameter values into the intermediate equations corresponding to example Equations 17A-20B above to determine the output parameters shown in Equations 28A-28H below, including the census audience sizes X_{(j,k)} and the census durations V_{(j,k)}.

$${f}^{\{ V \}} = [ \begin{matrix}2.15569 & 6.60555 \\ 3.50365 & 1.73285\end{matrix} ] \qquad ( Equation 28 A )$$

$$o = [ \begin{matrix}0.359282 & 0.825694 \\ 1.16788 & 2.16607\end{matrix} ] \qquad ( Equation 28 B )$$

$$P = [ \begin{matrix}2.94677 & 5.78027\end{matrix} ] \qquad ( Equation 28 C )$$

$${o}_{( , - )} = [ \begin{matrix}0.389353 & 0.210894\end{matrix} ] \qquad ( Equation 28 D )$$

$${X}_{( , - )} = [ \begin{matrix}280.241 & 348.328\end{matrix} ] \qquad ( Equation 28 E )$$

$${Q}^{\{ X \}} = [ \begin{matrix}424.193 & 421.196\end{matrix} ] \qquad ( Equation 28 F )$$

$$X = [ \begin{matrix}112.122 & 190.491 \\ 228.521 & 288.161\end{matrix} ] \qquad ( Equation 28 G )$$

$$V = [ \begin{matrix}241.7 & 1258.3 \\ 800.659 & 499.341\end{matrix} ] \qquad ( Equation 28 H )$$

In some examples, the example report generation circuitry 312 generates a report including the panel audience sizes, the panel durations, the census audience sizes, and the census durations. In this example, the report generation circuitry 312 generates the example Tables 8, 9, and 10 below, with the numbers rounded.

TABLE 8
Demographic index k = 1, U₍₁₎ = 1,000

| | Panel | | Census | |
|---|---|---|---|---|
| Dim. | Audience | Duration | Audience | Duration |
| 1 | 100 | 200 | 112 | 242 |
| 2 | 200 | 600 | 229 | 801 |
| Total | 250 | | 280 | |

TABLE 9
Demographic index k = 2, U₍₂₎ = 2,000

| | Panel | | Census | |
|---|---|---|---|---|
| Dim. | Audience | Duration | Audience | Duration |
| 1 | 150 | 800 | 190 | 1,258 |
| 2 | 250 | 400 | 288 | 499 |
| Total | 300 | | 348 | |

TABLE 10
Total Across Demographics

| | Panel | | Census | |
|---|---|---|---|---|
| Dim. | Audience | Duration | Audience | Duration |
| 1 | 250 | 1,000 | 302 | 1,500 |
| 2 | 450 | 1,000 | 517 | 1,300 |
| Total | 550 | | 628 | |

In a second example, the known panel data represented in example Tables 5 and 6 above remains the same, but the known census data is different. For example, example Table 7B below represents totals across the demographics k={1,2} when the total aggregate census duration V_{(•,•)} is known (e.g., instead of the aggregate census durations per dimension V_{(j,•)} as shown in example Table 7A above).

TABLE 7B
Total Across Demographics

| | Panel | | Census | |
|---|---|---|---|---|
| Dim. | Audience | Duration | Audience | Duration |
| 1 | 250 | 1,000 | X_{(1, •)} | V_{(1, •)} |
| 2 | 450 | 1,000 | X_{(2, •)} | V_{(2, •)} |
| Total | 550 | | | 2,800 |

In the first example corresponding to example Table 7A above, constraints on the census durations can be summarized as shown in example Equation 29 below.

$${V}_{( - , )} = [ \begin{matrix}1500 \\ 2800\end{matrix} ] \qquad ( Equation 29 )$$

Alternatively, in the second example, the aggregate census durations per dimension (e.g., V_{(j,•)}) are unknown, but the total aggregate census duration (e.g., V_{(•,•)}) is known. As such, the constraint on the census duration for the second example corresponding to example Table 7B above is represented below in example Equation 30.

V_{(•,•)}=[2800] (Equation 30)

In the second example, the known data and the summary parameter values correspond to the values shown in example Equations 23A-23E and 24A-24E above. However, while each dimension j in the first example had a corresponding constraint parameter c₍ⱼ₎^{{V}} associated therewith, the constraint parameters in the second example are based on a total across the dimensions (e.g., instead of individual dimensions). As such, the constraint parameters are the same across all dimensions and demographics and, thus, can be represented using a single parameter value as shown in example Equation 31 below.

c₍₁₎^{{V}}=c₍₂₎^{{V}}=c^{{V}} (Equation 31)

In this example, the example constraint equation control circuitry 306 selects an example range for the single constraint parameter c^{{V}} based on example Equation 21 above and the panel audience sizes A_{(j,k)} and the panel durations D_{(j,k)}. In particular, constraint equation control circuitry 306 selects an upper threshold of the range by selecting a lesser value from the ratios of panel audience sizes A_{(j,k)} to panel durations D_{(j,k)} for each demographic k, represented in example Equation 32 below.

$$max [ \begin{matrix}- ∞ \\ - ∞\end{matrix} ] < {c}^{\{ V \}} \leq min [ \begin{matrix}0.1875 \\ 0.333333\end{matrix} ] \qquad ( Equation 32 )$$

In some examples, the range shown in example Equation 32 above can be simplified as shown in example Equation 33 below.

−∞<c^{{V}}≤0.187500 (Equation 33)

In this example, the example constraint equation control circuitry 306 selects a constraint equation based on the known relationship between the individual census durations V_{(j,k)} and the total aggregate census duration V_{(•,•)}. In particular, the constraint equation control circuitry 306 selects example Equation 34 below which shows that a sum of the individual census durations corresponds to the known total aggregate census duration V_{(•, •)}.

V_{(1,1)}+V_{(1,2)}+V_{(2,1)}+V_{(2,2)}=2800 (Equation 34)

In some examples, each of the individual census durations V_{(j,k)} can be written as a function of the constraint parameter c^{{V}} (e.g., by substituting example Equations 7A-20B above into example Equation 34 above). Thus, the example constraint parameter estimation circuitry 308 can solve example Equation 34 above to determine a value for the constraint parameter c^{{V}} as shown in example Equation 35 below.

c^{{V}}=0.0395847 (Equation 35)

The example output generation circuitry 310 iteratively substitutes the determined value tier c^{{V}} of example Equation 35 above and the panel parameters of example Equations 23A-23E and 24A-24E above into example Equations 17A-20B above to determine the output parameters shown in Equations 36A-36H below, including the census audience sizes X _{(j,k)} and the census durations V_{(j,k)}.

$${f}^{\{ V \}} = [ \begin{matrix}2.17195 & 6.76062 \\ 3.40427 & 1.70819\end{matrix} ] \qquad ( Equation 36 A )$$

$$o = [ \begin{matrix}0.361992 & 0.845078 \\ 1.13476 & 2.13524\end{matrix} ] \qquad ( Equation 36 B )$$

$$P = [ \begin{matrix}2.90752 & 5.78476\end{matrix} ] \qquad ( Equation 36 C )$$

$${o}_{( , - )} = [ \begin{matrix}0.381504 & 0.211092\end{matrix} ] \qquad ( Equation 36 D )$$

$${X}_{( , - )} = [ \begin{matrix}276.151 & 348.598\end{matrix} ] \qquad ( Equation 36 E )$$

$${Q}^{\{ X \}} = [ \begin{matrix}420.921 & 421.454\end{matrix} ] \qquad ( Equation 36 F )$$

$$X = [ \begin{matrix}111.873 & 193.033 \\ 223.746 & 287.029\end{matrix} ] \qquad ( Equation 36 G )$$

$$V = [ \begin{matrix}242.983 & 1305.03 \\ 761.692 & 490.3\end{matrix} ] \qquad ( Equation 36 H )$$

In some examples, the example report generation circuitry 312 generates a report including the panel audience sizes, the panel durations, the estimated census audience sizes, and the estimated census durations. In this example, the report generation circuitry 312 generates example Tables 11, 12, and 13 below, with the numbers rounded.

TABLE 11
Demographic index k = 1, U₍₁₎ = 1,000

| | Panel | | Census | |
|---|---|---|---|---|
| Dim. | Audience | Duration | Audience | Duration |
| 1 | 100 | 200 | 112 | 243 |
| 2 | 200 | 600 | 224 | 762 |
| Total | 250 | | 276 | |

TABLE 12
Demographic index k = 2, U₍₂₎ = 2,000

| | Panel | | Census | |
|---|---|---|---|---|
| Dim. | Audience | Duration | Audience | Duration |
| 1 | 150 | 800 | 193 | 1,305 |
| 2 | 250 | 400 | 287 | 490 |
| Total | 300 | | 349 | |

TABLE 13
Total Across Demographics

| | Panel | | Census | |
|---|---|---|---|---|
| Dim. | Audience | Duration | Audience | Duration |
| 1 | 250 | 1,000 | 305 | 1,548 |
| 2 | 450 | 1,000 | 511 | 1,252 |
| Total | 550 | | 625 | 2,800 |

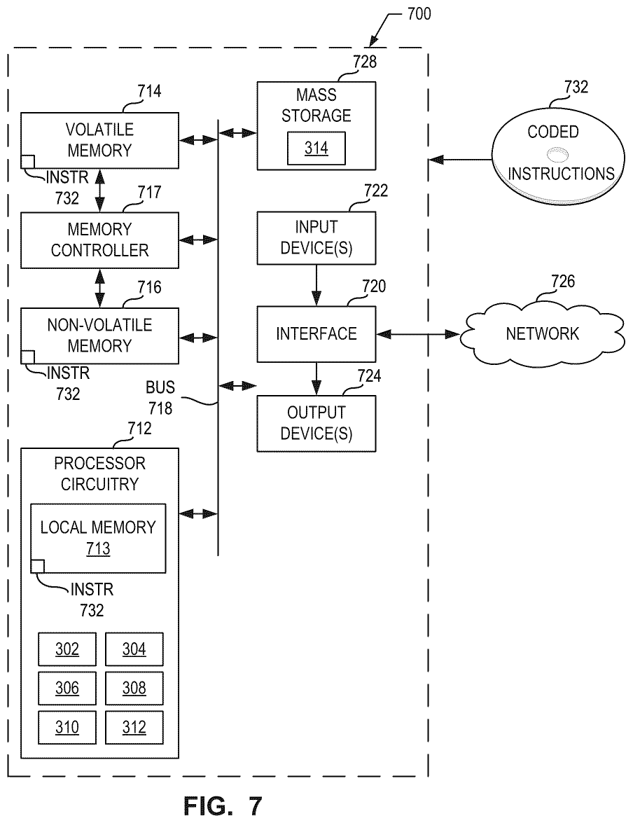

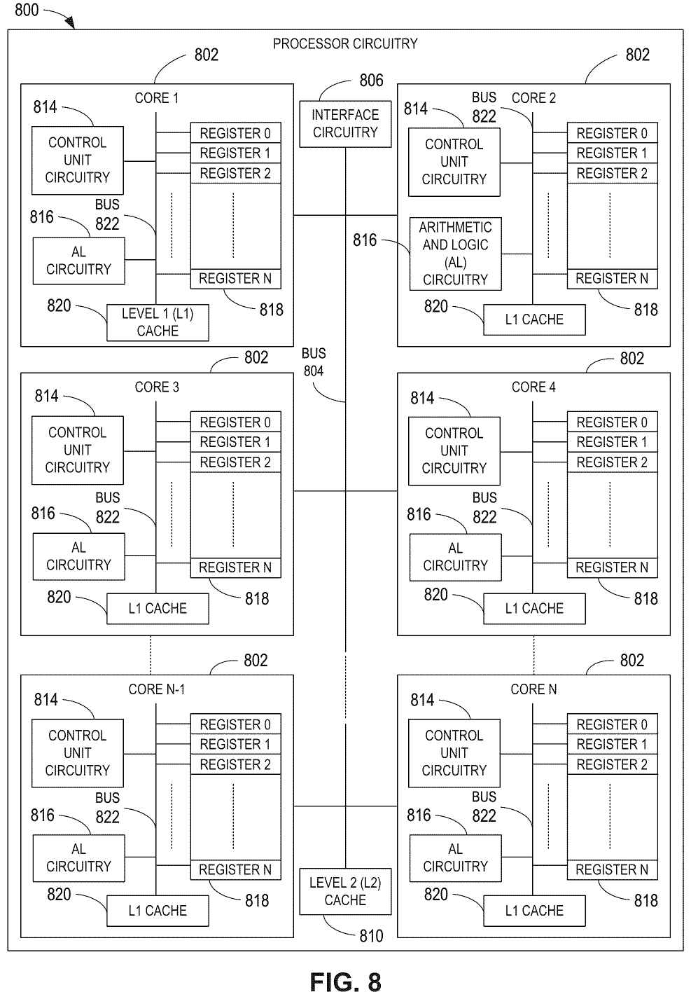

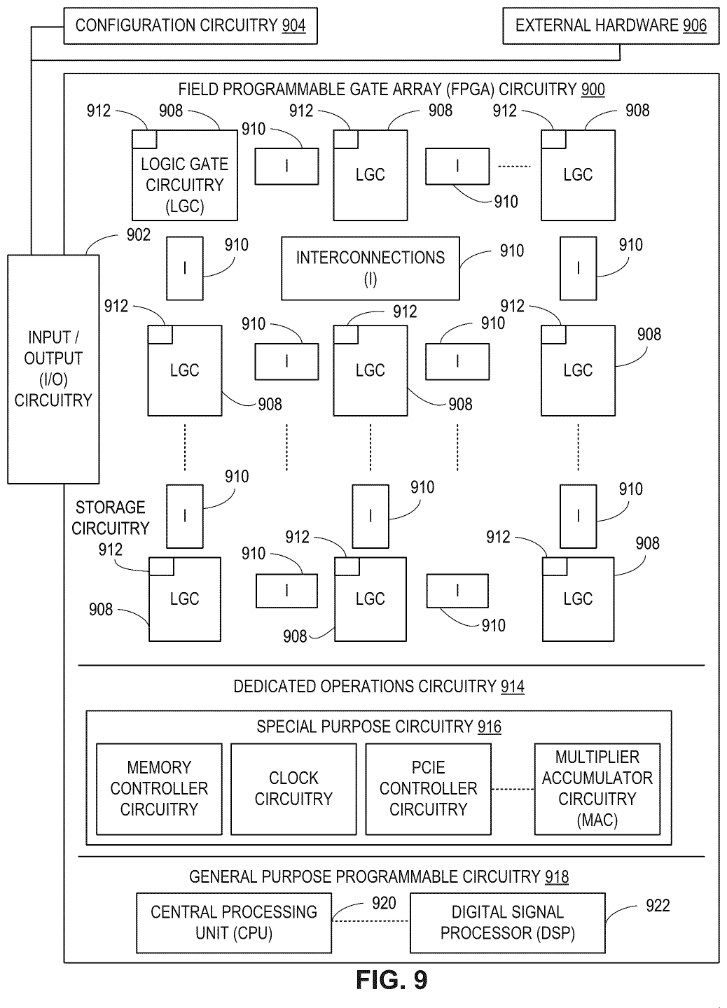

In some examples, the audience estimate control circuitry 110 includes means for obtaining data. For example, the means for obtaining data may be implemented by the network interface circuitry 302. In some examples, the network interface circuitry 302 may be instantiated by interface circuitry of a processor platform such as the interface circuitry 720 of the processor platform 700 of FIG. 7. For instance, the network interface circuitry 302 may be instantiated by the example microprocessor 800 of FIG. 8 executing machine executable instructions such as those implemented by at least block 402 of FIG. 4 to cause the interface circuitry 720 to perform data access operations. In some examples, the network interface circuitry 302 may be instantiated by hardware logic circuitry, which may be implemented by an ASIC, XPU, or the FPGA circuitry 900 of FIG. 9 structured to perform operations corresponding to the machine readable instructions that cause the interface circuitry 720 to perform data access operations. Additionally or alternatively, the network interface circuitry 302 may be instantiated by any other combination of hardware, software, and/or firmware. For example, the network interface circuitry 302 may be implemented by at least one or more hardware circuits (e.g., processor circuitry, discrete and/or integrated analog and/or digital circuitry, an FPGA, an ASIC, are XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audience estimate control circuitry 110 includes means for calculating summary parameter values. For example, the means for calculating summary parameter values may be implemented by the summary parameter calculation circuitry 304. In some examples, the summary parameter calculation circuitry 304 may be instantiated by processor circuitry such as the example processor circuitry 712 of FIG. 7. For instance, the summary parameter calculation circuitry 304 may be instantiated by the example microprocessor 800 of FIG. 8 executing machine executable instructions such as those implemented by at least block 404 of FIG. 4. In some examples, the summary parameter calculation circuitry 304 may be instantiated by hardware logic circuitry, which may be implemented by an ASIC, XPU, or the RIGA circuitry 900 of FIG. 9 structured to perform operations corresponding to the machine readable instructions. Additionally or alternatively, the summary parameter calculation circuitry 304 may be instantiated by any other combination of hardware, software, and/or firmware. For example, the summary parameter calculation circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

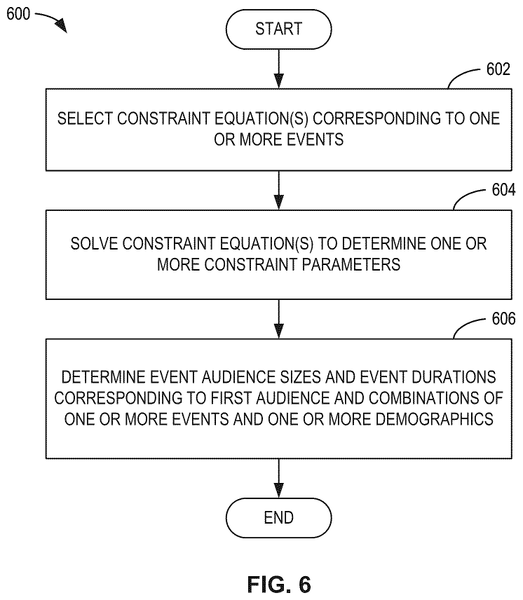

In some examples, the audience estimate control circuitry 110 includes means for selecting at least one constraint equation. For example, the means for selecting at least one constraint equation may be implemented by the constraint equation control circuitry 306. In some examples, the constraint equation control circuitry 306 may be instantiated by processor circuitry such as the example processor circuitry 712 of FIG. 7. For instance, the constraint equation control circuitry 306 may be instantiated by the example microprocessor 800 of FIG. 8 executing machine executable instructions such as those implemented by at least blocks 406, 408 of FIG. 4 and/or block 602 of FIG. 6. In some examples, the constraint equation control circuitry 306 may be instantiated by hardware logic circuitry, which may be implemented by an ASIC, XPU, or the FPGA circuitry 900 of FIG. 9 structured to perform operations corresponding to the machine readable instructions. Additionally or alternatively, the constraint equation control circuitry 306 may be instantiated by any other combination of hardware, software, and/or firmware. For example, the constraint equation control circuitry 306 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audience estimate control circuitry 110 includes means for determining one or more constraint parameter values. For example, the means for determining one or more constraint parameter values may be implemented by the constraint parameter estimation circuitry 308. In some examples, the constraint parameter estimation circuitry 308 may be instantiated by processor circuitry such as the example processor circuitry 712 of FIG. 7. For instance, the constraint parameter estimation circuitry 308 may be instantiated by the example microprocessor 800 of FIG. 8 executing machine executable instructions such as those implemented by at least blocks 410, 412 of FIG. 4 and/or block 604 of FIG. 6. In some examples, the constraint parameter estimation circuitry 308 may be instantiated by hardware logic circuitry, which may be implemented by an ASIC, XPU, or the FPGA circuitry 900 of FIG. 9 structured to perform operations corresponding to the machine readable instructions, Additionally or alternatively, the constraint parameter estimation circuitry 308 may be instantiated by any other combination of hardware, software, and/or firmware. For example, the constraint parameter estimation circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

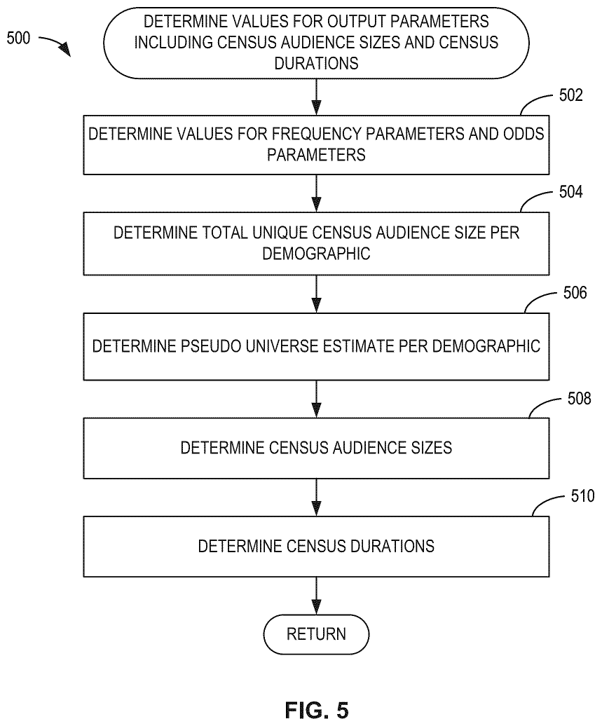

In some examples, the audience estimate control circuitry 110 includes means for determining an event audience size and/or an event duration. For example, the means for determining an event audience size and/or an event duration may be implemented by the output generation circuitry 310. In some examples, the output generation circuitry 310 may be instantiated by processor circuitry such as the example processor circuitry 712 of FIG. 7. For instance, the output generation circuitry 310 may be instantiated by the example microprocessor 800 of FIG. 8 executing machine executable instructions such as those implemented by at least block 414 of FIG. 4, blocks 502, 504, 506, 508, 510 of FIG. 5, and/or block 606 of FIG. 6. In some examples, the output generation circuitry 310 may be instantiated by hardware logic circuitry, which may be implemented by an ASIC, XPU, or the FPGA circuitry 900 of FIG. 9 structured to perform operations corresponding to the machine readable instructions, Additionally or alternatively, the output generation circuitry 310 may be instantiated by any other combination of hardware, software, and/or firmware. For example, the output generation circuitry 310 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the audience estimate control circuitry 110 includes means for generating a report. For example, the means for generating a report may be implemented by the report generation circuitry 312. In some examples, the report generation circuitry 312 may be instantiated by processor circuitry such as the example processor circuitry 712 of FIG, 7. For instance, the report generation circuitry 312 may be instantiated by the example microprocessor 800 of FIG. 8 executing machine executable instructions such as those implemented by at least block 416 of FIG. 4. In some examples, the report generation circuitry 312 may be instantiated by hardware logic circuitry, which may be implemented by an ASIC, XPU, or the FPGA circuitry 900 of FIG. 9 structured to perform operations corresponding to the machine readable instructions. Additionally or alternatively, the report generation circuitry 312 may be instantiated by any other combination of hardware, software, and/or firmware. For example, the report generation circuitry 312 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example audience estimate control circuitry 110 of FIGS. 1 and/or 2 is illustrated in FIG. 3, one or more of the elements, processes, and/or devices illustrated in FIG. 3 may be combined, divided, re-arranged, omitted, eliminated, and/or implemented in any other way. Further, the example network interface circuitry 302, the example summary parameter calculation circuitry 304, the example constraint equation control circuitry 306, the example constraint parameter estimation circuitry 308, the example output generation circuitry 310, the example report generation circuitry 312, the example audience estimate database 314, and/or, more generally, the example audience estimate control circuitry 110 of FIG. 1, may be implemented by hardware alone or by hardware in combination with software and/or firmware. Thus, for example, any of the example network interface circuitry 302, the example summary parameter calculation circuitry 304, the example constraint equation control circuitry 306, the example constraint parameter estimation circuitry 308, the example output generation circuitry 310, the example report generation circuitry 312, the example audience estimate database 314, and/or, more generally, the example audience estimate control circuitry 110, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example audience estimate control circuitry 110 of FIGS. 1 and/or 2 may include one or more elements, processes, and/or devices in addition to, or instead of, those illustrated in FIG. 3, and/or may include more than one of any or all of the illustrated elements, processes and devices.

Flowcharts representative of example machine readable instructions, which may be executed to configure processor circuitry to implement the audience estimate control circuitry 110 of FIG. 3, are shown in FIGS. 4, 5, and 6. The machine readable instructions may be one or more executable programs or portion(s) of an executable program for execution by processor circuitry, such as the processor circuitry 712 shown in the example processor platform 700 discussed below in connection with FIG. 7 and/or the example processor circuitry discussed below in connection with FIGS. 8 and/or 9. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 4, 5, and/or 6, many other methods of implementing the example audience estimate control circuitry 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine, For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4, 5, and/or 6 may be implemented using executable instructions(e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media, Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc,

“Including” and “comprising” (and all forms and tenses thereof) are used herein to be open ended terms. Thus, whenever a claim employs any form of “include” or “comprise” (e.g., comprises, includes, comprising, including, having, etc,) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “al least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions and/or example operations 400 that may be executed and/or instantiated by processor circuitry to determine census audience sizes and census durations. The example machine readable instructions and/or the operations 400 of FIG. 4 begin at block 402, at which the example audience estimate control circuitry 110 of FIGS. 1, 2, and/or 3 accesses known panel data and known census data. For example, the example network interface circuitry 302 of FIG. 3 accesses the known panel data from the example panel database 102 of FIG. 1, and accesses the known census data from the example census database 104 of FIG. 1. In some examples, the known panel data includes panel audience sizes (e.g., A_{(j,k)}) and panel durations (e.g., D_{(j,k)}) across the n dimensions and K demographics, aggregate panel audience sizes per demographic (e.g., A_{(•,k)}), and universe estimates per demographic (e.g., U₍ₖ₎). In some examples, the known census data includes at least one of aggregate census durations per dimension (e.g., V_{(j,•)}) or a total aggregate census duration (e.g., V_{(•, •)}) across the n dimensions and the K demographics.

At block 404, the example audience estimate control circuitry 110 calculates summary parameters based on the known panel data, For example, the example summary parameter calculation circuitry 304 of FIG. 3 calculates the summary parameters z_{(j,k)}^{{a}}, z_{(j,k)}^{{d}}, z₍ₖ₎^{{•}}, z₍ₖ₎^{{0}}, Q₍ₖ₎^{{A}} based on example Equations 6A, 6B, 6C, 6D, and 7 above. For example, the summary parameter calculation circuitry 304 substitutes the known panel data {A_{(j,k)}, D_{(j,k)}, A_{(•,k)}, U₍ₖ₎} into Equations 6A, 6B, 6C, 6D, and 7 above to calculate values for the summary parameters.

At block 406, the example audience estimate control circuitry 110 selects one or more constraint equations. For example, the example constraint equation control circuitry 306 of FIG. 3 selects the constraint equations corresponding to example Equations 17A-22 above, where the constraint equations are a function of N constraint parameters (e.g.. c₍ⱼ₎^{{V}}). In some examples, the constraint equation control circuitry 206 selects example Equation 22 above corresponding to multiple (e.g., all) of the N dimensions to be solved for because Equation 22 enables solving for values for the constraint parameters simultaneously (e.g., in parallel, concurrently, etc.) across the multiple dimensions. In some such examples, the constraint equation control circuitry 206 selects one or more of example Equations 17A-above to iteratively substitute into example Equation 22 above for the N dimensions to produce a system of N equations written in terms of the N constraint parameters.

At block 408, the example audience estimate control circuitry 110 selects a range for the constraint parameters. For example, the constraint equation control circuitry 306 (FIG. 3) selects the range for each of the N constraint parameters based on example Equation 21 above. In some examples, the range indicates that each of the constraint parameters are at or below a threshold, where the threshold is based on a ratio of the panel audience sizes to the panel durations.

At block 410, the example audience estimate control circuitry 110 solves the constraint equation(s) to determine values for the constraint parameters. For example, the example constraint parameter estimation circuitry 308 of FIG. 3 substitutes the summary parameters, the known panel data, and the known census data into the constraint equations, and solves the constraint equations to determine the values for the constraint parameters. In some examples, the constraint parameter estimation circuitry 308 uses a numerical algorithm to solve the constraint equations for the constraint parameters. In some examples, the constraint parameter estimation circuitry 308 substantially reduces processing time by determining unknown parameter value estimates using a predetermined set of the constraint equations, thus enabling simultaneous (e.g., parallel, concurrent, etc.) estimation across the N dimensions and/or K demographics (e.g., compared to previous methods in which the unknown parameter values are estimated for the K demographics seriatim instead of in parallel).

At block 412, the example audience estimate control circuitry 110 substitutes the values for the constraint parameters into one or more of the constraint equations. For example, the constraint parameter estimation circuitry 308 (FIG. 3) substitutes the values of the constraint parameters determined at block 410 into the one(s) of the constraint equations such that the one(s) of the constraint equations can be used to solve for unknown output parameters.

At block 414, the example audience estimate control circuitry 110 determines values for output parameters including census audience sizes (e.g., X_{j,k)}) and census durations (e.g., V_{(j,k)}). For example, the example output generation circuitry 310 of FIG. 3 determines values for the output parameters based on the constraint equations selected at block 406 and the values of the constraint parameters determined at block 410. Determining values for the output parameters is disclosed further in detail below in connection with FIG. 5. In some examples, by determining the census audience sizes and census durations using an analytical approach based on example Equations 17A-22 above, the output generation circuitry 310 reduces computer-generated error in the estimated census audience sizes and estimated census durations compared to previous methods in which iteration-based approximation methods are used. For example, such computer-generated error may be a result of not accounting for particular constraints during estimation of the census audience sizes and/or census durations. In particular, previous methods do not account for the constraint on total census duration as represented in example Equation 22 above. Accordingly, the computer-generated error includes census audience size and census duration estimations that are mathematically correct, but realistically incorrect (e.g., negative values for the census audience sizes and/or census durations). However, by including the additional constraint on total census duration as represented in example Equation 22 above, examples disclosed herein reduce a range of possible values for the census audience sizes and/or census durations, thus reducing the computer-generated error resulting from estimation using fewer constraints.

At block 416, the example audience estimate control circuitry 110 generates a report. For example, the example report generation circuitry 312 of FIG. 3 generates a report including the census audience sizes and/or the census durations across the n dimensions and the K demographics. In some examples, the report may further include the known panel data (e.g., the panel audience sizes and/or the panel data) and/or one or more other output parameters. In some examples, additionally or alternatively, the audience estimate database 314 stores the census audience sizes and/or the census durations. The program 400 ends.

FIG. 5 is a flowchart representative of example machine readable instructions and/or example operations 500 that may be executed and/or instantiated by processor circuitry to determine values for output parameters including census audience sizes and census durations in connection with block 414 of FIG. 4. The example machine readable instructions and/or the operations 500 of FIG. 5 begin at block 502, at which the example audience estimate control circuitry 110 of FIGS. 1, 2, and/or 3 determines frequency parameter values and odds parameter values. For example, the example output generation circuitry 310 of FIG. 3 determines values for the frequency parameters (e.g., f_{(j,k)}^{{V}}) based on example Equation 17B above by substituting values for the panel audience sizes (e.g., A_{(j,k)}), the panel durations (e.g., D_{(j,k)}), and the constraint parameters (e.g., c₍ⱼ₎^{{V}}) into example Equation 17B. Further, the output generation circuitry 310 determines values for the odds parameters (e.g., o_{(j,k)}) based on example Equation 17C above by substituting values for the frequency parameters and the summary parameters (e.g., z_{(j,k)}^{{a,Q}}) into example Equation 17C.

At block 504, the example audience estimate control circuitry 110 determines the total unique census audience size per demographic. For example, the output generation circuitry 310 (FIG. 3) determines the total unique census audience size per demographic (e.g., X_{(•,k)} based on example Equation 18C above by substituting values for aggregate odds parameters (e.g., o_{(•,k)}) and known universe estimates (e.g., U₍ₖ₎) into example Equation 18C. In such examples, to determine the values for the aggregate odds parameters, the output generation circuitry 310 determines values for probability parameters (e.g., P₍ₖ₎) based on example Equation 18A above by substituting the values for the odds parameters (e.g., o_{(j,k)}) into example Equation 18A, then substituting the determined values for the probability parameters and the summary parameter z_{(j,k)}^{{a,Q}} into example Equation 18B above.

At block 506, the example audience estimate control circuitry 110 determines a pseudo universe estimate per demographic. For example, the output generation circuitry 310 (FIG. 3) determines the pseudo universe estimate per demographic (e.g., Q₍ₖ₎^{{X}}) based on example Equation 19 above by substituting values for the total unique census audience per demographic (e.g., X_{(•,k)}) and the probability parameters (e.g., P₍ₖ₎ into example Equation 19.

At block 508, the example audience estimate control circuitry 110 determines census audience sizes. For example, the output generation circuitry 310 (FIG. 3) determines the census audience sizes (e.g., X_{(j,k)}) corresponding to each dimension j and demographic k combination based on example Equation 20A above by substituting values for the pseudo universe estimate per demographic (e.g., Q₍ₖ₎^{{X}}) and the odds parameters (e.g., o_{(j,k)}) into example Equation 20A.

At block 510. the example audience estimate control circuitry 110 determines census durations. For example, the output generation circuitry 310 (FIG. 3) determines the census audience sizes (e.g., V_{(j,k)}) corresponding to each dimension j and demographic k combination based on example Equation 20A above by substituting values for the pseudo universe estimate per demographic (e.g., Q₍ₖ₎^{{X}}) and the odds parameters (e.g., o_{(j,k)}) into example Equation 20A. In some examples, by solving for the output parameter values using predetermined equations as described in connection with blocks 502, 504, 506, 508, and 510 above, examples disclosed herein reduce processing time compared to other methods in which the output parameter values are estimated using numerical iteration-based approximation. Further, examples disclosed herein solve for the output parameter values across multiple demographics simultaneously (e.g., in parallel, concurrently, etc.), thus reducing processing time compared to other methods in which each demographic is solved for seriatim instead of in parallel). The example instructions of FIG. 5 end and control proceeds to block 416 of FIG. 4.

FIG. 6 is a flowchart representative of example machine readable instructions and/or example operations 600 that may be executed and/or instantiated by processor circuitry to estimate census audience sizes and census durations. The example machine readable instructions and/or the operations 600 of FIG. 6 begin at block 602, at which the example audience estimate control circuitry 110 of FIGS. 1, 2, and/or 3 selects one or more constraint equations corresponding to one or more events. In example FIG. 6, the one or more events correspond to first audience members and second audience members, the first audience members to include the second audience members. For example, the example constraint equation control circuitry 306 of FIG. 3 selects Equation 22 above corresponding to each of the one or more events (e.g., events j={1, 2, . . . n} such as accessing a website, accessing media, etc.). In such examples, the constraint equations are a function of one or more constraint parameters c₍ⱼ₎^{{V}}. In some examples, the panel audience sizes A_{(j,k)}, the panel durations D_{(j,k)}, the aggregate panel audience sizes per demographic A_{(•,k)}, and the universe estimates U₍ₖ₎ are known, and the census audience sizes X_{(j,k)} and the panel durations V_{(j,k)} are unknown. In this example, the first audience members correspond to the census audience, and the second audience members correspond to the panel audience.

At block 604, the example audience estimate control circuitry 110 solves the one or more constraint equations to determine one or more constraint parameter values. In the example of FIG. 6, the one or more constraint parameter values correspond to the one or more events, For example, the example constraint parameter estimation circuitry 308 of FIG. 3 solves the constraint equations for the unknown values of the constraint parameters c₍ⱼ₎^{{V}}.

At block 606, the example audience estimate control circuitry 110 determines event audience sizes and event durations corresponding to (a) the first audience and (b) combinations of the one or more events and one or more demographics. For example, the example output generation circuitry 310 of FIG. 3 determines unknown values for the event audience sizes (e.g., the census audience sizes X_{(j,k)}) and the event durations (e.g., the census durations V_{(j,k)}) by substituting the constraint parameter values into the intermediate equations corresponding to example Equations 17A-20B above. The program 600 ends.

FIG. 7 is a block diagram of an example processor platform 700 structured to execute and/or instantiate the machine readable instructions and/or the operations of FIGS. 4, 5, and/or 6 to implement the audience estimate control circuitry 110 of FIG. 3. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, a headset (e.g., an augmented reality (AR) headset, a virtual reality (VR) headset, etc.) or other wearable device, or any other type of computing device.

The processor platform 700 of the illustrated example includes processor circuitry 712. The processor circuitry 712 of the illustrated example is hardware. For example, the processor circuitry 712 can be implemented by one or more integrated circuits, logic circuits, FPGAs, microprocessors, CPUs, GPUs, DSPs, and/or microcontrollers from any desired family or manufacturer. The processor circuitry 712 may be implemented by one or more semiconductor based (e.g., silicon based) devices. In this example, the processor circuitry 712 implements the example network interface circuitry 302, the example summary parameter calculation circuitry 304, the example constraint equation control circuitry 306, the example constraint parameter estimation circuitry 308, the example output generation circuitry 310, the example report generation circuitry 312, and the example audience estimate database 314.

The processor circuitry 712 of the illustrated example includes a local memory 713 (e.g., a cache, registers, etc.). The processor circuitry 712 of the illustrated example is in communication with a main memory including a volatile memory 714 and a non-volatile memory 716 by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717.

The processor platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user to enter data and/or commands into the processor circuitry 712. The input device(s) 722 can be implemented by, for example, an audio sensor, a microphone, a camera (still or video), a keyboard, a button, a mouse, a touchscreen, a track-pad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 700 of the illustrated example also includes one or more mass storage devices 728 to store software and/or data. Examples of such mass storage devices 728 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 732, which may be implemented by the machine readable instructions of FIGS. 4, 5, and/or 6, may be stored in the mass storage device 728, in the volatile memory 714, in the non-volatile memory 716, and/or on a removable non-transitory computer readable storage medium such as a CD or DVD.

FIG. 8 is a block diagram of an example implementation of the processor circuitry 712 of FIG. 7. In this example, the processor circuitry 712 of FIG. 7 is implemented by a microprocessor 800. For example, the microprocessor 800 may be a general purpose microprocessor (e.g., general purpose microprocessor circuitry). The microprocessor 800 executes some or all of the machine readable instructions of the flowcharts of FIGS. 4, 5, and/or 6 to effectively instantiate the audience estimate control circuitry 110 of FIG. 3 as logic circuits to perform the operations corresponding to those machine readable instructions. In some such examples, the audience estimate control circuitry 110 of FIG. 3 is instantiated by the hardware circuits of the microprocessor 800 in combination with the instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 4, 5, and/or 6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared. memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load./store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating point operations. In yet other examples, the AL circuitry 816 may include first AL circuitry that performs integer based operations and second AL circuitry that performs floating point operations. In some examples, the AL circuitry 816 may be referred to as an Arithmetic Logic Unit (ALU). The registers 818 are semiconductor-based structures to store data and/or instructions such as results of one or more of the operations performed by the AL circuitry 816 of the corresponding core 802. For example, the registers 818 may include vector register(s), SIMD register(s), general purpose register(s), flag register(s), segment register(s), machine specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure including distributed throughout the core 802 to shorten access time. The second bus 822 may be implemented by at least one of an I2C bus, a SPI bus, a PCI bus, or a PCIe bus

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 9 is a block diagram of another example implementation of the processor circuitry 712 of FIG. 7. In this example, the processor circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the machine readable instructions in hardware and, thus, can often execute the operations faster than they could be performed by a general purpose microprocessor executing the corresponding software.

More specifically, in contrast to the microprocessor 800 of FIG. 8 described above (which is a general purpose device that may be programmed to execute some or all of the machine readable instructions represented by the flowcharts of FIGS. 4, 5, and/or 6 but whose interconnections and logic circuitry are fixed once fabricated), the FPGA circuitry 900 of the example of FIG. 9 includes interconnections and logic circuitry that may be configured and/or interconnected in different ways after fabrication to instantiate, for example, some or all of the machine readable instructions represented by the flowcharts of FIGS. 4, 5, and/or 6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the software represented by the flowcharts of FIGS. 4, 5, and/or 6. As such, the FPGA circuitry 900 may be structured to effectively instantiate some or all of the machine readable instructions of the flowcharts of FIGS. 4, 5, and/or 6 as dedicated logic circuits to perform the operations corresponding to those software instructions in a dedicated manner analogous to an ASIC. Therefore, the FPGA circuitry 900 may perform the operations corresponding to the some or all of the machine readable instructions of FIGS. 4, 5, and/or 6 faster than the general purpose microprocessor can execute the same.

In the example of FIG. 9, the FPGA circuitry 900 is structured to be programmed (and/or reprogrammed one or more times) by an end user by a hardware description language (HDL) such as Verilog. The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuit that may obtain machine readable instructions to configure the FPGA circuitry 900, or portion(s) thereof. In some such examples, the configuration circuitry 904 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 906 may be implemented by external hardware circuitry. For example, the external hardware 906 may be implemented by the microprocessor 800 of FIG. 8. The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations that may correspond to at least some of the machine readable instructions of FIGS. 4, 5, and/or 6 and/or other desired operations. The logic gate circuitry 908 shown in FIG. 9 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed loo programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example Dedicated Operations Circuitry 914. In this example, the Dedicated Operations Circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the processor circuitry 712 of FIG. 7, many other approaches are contemplated. For example, as mentioned above, modern FPGA circuitry may include an on-board CPU, such as one or more of the example CPU 920 of FIG. 9. Therefore, the processor circuitry 712 of FIG. 7 may additionally be implemented by combining the example microprocessor 800 of FIG. 8 and the example FPGA circuitry 900 of FIG. 9. In some such hybrid examples, a first portion of the machine readable instructions represented by the flowcharts of FIGS. 4, 5, and/or 6 may be executed by one or more of the cores 802 of FIG. 8, a second portion of the machine readable instructions represented by the flowcharts of FIGS. 4, 5, and/or 6 may be executed by the FPGA circuitry 900 of FIG. 9, and/or a third portion of the machine readable instructions represented by the flowcharts of FIGS. 4, 5, and/or 6 may be executed by an ASIC. It should be understood that some or all of the audience estimate control circuitry 110 of FIG. 3 may, thus, be instantiated at the same or different times. Some or all of the circuitry may be instantiated, for example, in one or more threads executing concurrently and/or in series. Moreover, in some examples, some or all of the audience estimate control circuitry 110 of FIG. 3 may be implemented within one or more virtual machines and/or containers executing on the microprocessor.

In some examples, the processor circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the processor circuitry 712 of FIG. 7, which may be in one or more packages. For example, the XPU may include a CPU in one package, a DSP in another package, a GPU in yet another package, and an FPGA in still yet another package.

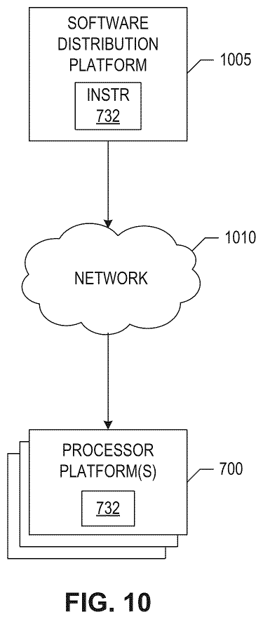

A block diagram illustrating an example software distribution platform 1005 to distribute software such as the example machine readable instructions 732 of FIG. 7 to hardware devices owned and/or operated by third parties is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions 400 of FIG. 4, the example machine readable instructions 500 of FIG. 5, and/or the example machine readable instructions 600 of FIG. 6 as described above. The one or more servers of the example software distribution platform 1005 are in communication with an example network 1010, which may correspond to any one or more of the Internet and/or the example network 106 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions 400 of FIG. 4, the example machine readable instructions 500 of FIG. 5, and/or the example machine readable instructions 600 of FIG. 6, may be downloaded to the example processor platform 700, which is to execute the machine readable instructions 732 to implement the audience estimate control circuitry 110 of FIG. 3. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices.

From the foregoing, it will be appreciated that the above disclosed examples may be used to estimate census-level audience sizes and/or census-level duration data. Traditional techniques to solve for unknown census data can be determined using the above system of example Equations 9A, 9B, 9C, and 10. However, such traditional techniques require a large amount of processor resources and/or memory. Also, the system of example Equations 9A, 9B, 9C, and 10 does not account for particular constraints, such as the relationship between census-level durations and the total aggregate census-level duration for a particular dimension. Accordingly, such traditional techniques may result in errors and/or result in audience size estimations that are mathematically correct, but realistically incorrect (e.g., negative values, errors, etc.). Accordingly, examples disclosed herein provide an analytical approach (e.g., using one or more of Equations 17A-22) to solve for unknown values, resulting in mathematically and/or realistically correct solutions that require less memory and processor resources than traditional techniques. The disclosed methods, apparatus and articles of manufacture improve the efficiency of using a computing device by estimating census parameter values (e.g., census audience sizes and census durations) for one or more events and one or more demographics based on panel audience sizes and panel durations for the one or more events and one or more demographics, thus enabling accurate estimation of the census parameter values when census-level data is limited. In some examples, the disclosed methods, apparatus and articles of manufacture substantially reduce processing time by determining census parameter value estimates using a predetermined set of equations that enable simultaneous (e.g., parallel or concurrent) estimation across multiple dimensions and/or demographics, thus reducing a number of equations required for respective ones of the multiple dimensions and/or demographics. Accordingly, the disclosed systems, methods, apparatus, and articles of manufacture are accordingly directed to one or more improvement(s) in the operation of a machine such as a computer or other electronic and/or mechanical device.

Example methods and apparatus to estimate census-level audience sizes and duration data across dimensions and/or demographics are disclosed herein. Further examples and combinations thereof include the following:

Example 1 includes an apparatus comprising constraint equation control circuitry to select at least one constraint equation corresponding to one or more events, the one or more events corresponding to first audience members and second audience members, the first audience members to include the second audience members, constraint parameter estimation circuitry to solve the at least one constraint equation to determine one or more constraint parameter values the one or more constraint parameter values corresponding to the one or more events, and output generation circuitry to determine, based on one or more intermediate equations and the one or more constraint parameter values, an event audience size and an event duration corresponding to (a) the first audience members and (b) a combination of the one or more events and one or more demographics.

Example 2 includes the apparatus of example 1, wherein the event audience size is a first event audience size, the event duration is a first event duration, the output generation circuitry to determine the first event audience size based on aggregate duration values, second event audience sizes , and second event durations the aggregate duration values corresponding to the first audience members, and the second event audience sizes and the second event durations corresponding to the second audience members and to the combination of the one or more events and the one or more demographics.

Example 3 includes the apparatus of example 2, wherein the constraint parameter estimation circuitry is to determine the one or more constraint parameter values based on a range, the range based on a ratio of the second event audience sizes to the second event durations.

Example 4 includes the apparatus of example 2, further including summary parameter calculation circuitry to calculate summary parameter values based on the second event audience sizes, the second event durations, and universe estimates corresponding to the one or more demographics.

Example 5 includes the apparatus of example 4, wherein the output generation circuitry is to determine output parameter values by iteratively solving the one or more intermediate equations based on the summary parameter values and the one or more constraint parameter values, the output parameter values including the first event audience size and the first event duration.

Example 6 includes the apparatus of example 1, further including report generation circuitry to generate a report including the event audience size and the event duration.

Example 7 includes the apparatus of example 1, wherein the one or more events include at least one of accessing a website, accessing an advertisement, or using a device type.

Example 8 includes a system comprising memory, programmable circuitry, and instructions to cause the programmable circuitry to select at least one constraint equation corresponding to one or more events, the one or more events corresponding to first audience members and second audience members, the first audience members to include the second audience members, solve the at least one constraint equation to determine one or more constraint parameter values, the one or more constraint parameter values corresponding to the one or more events, and determine, based on one or more intermediate equations and the one or more constraint parameter values, an event audience size and an event duration corresponding to (a) the first audience members and (b) a combination of the one or more events and one or more demographics.

Example 9 includes the system of example 8, wherein the event audience size is a first event audience size, the event duration is a first event duration, the programmable circuitry to determine the first event audience size based on aggregate duration values, second event audience sizes, and second event durations, the aggregate duration values corresponding to the first audience members, and the second event audience sizes and the second event durations corresponding to the second audience members and to the combination of the one or more events and the one or more demographics.

Example 10 includes the system of example 9, wherein the programmable circuitry is to determine the one or more constraint parameter values based on a range, the range based on a ratio of the second event audience sizes to the second event durations.

Example 11 includes the system of example 9, wherein the programmable circuitry is to calculate summary parameter values based on the second event audience sizes, the second event durations, and universe estimates corresponding to the one or more demographics.

Example 12 includes the system of example 11, wherein the programmable circuitry is to determine output parameter values by iteratively solving the one or more intermediate equations based on the summary parameter values and the one or more constraint parameter values, the output parameter values including the first event audience size and the first event duration.

Example 13 includes the system of example 8, wherein the programmable circuitry is to generate a report including the event audience size and the event duration.

Example 14 includes the system of example 8, wherein the one or more events include at least one of accessing a website, accessing an advertisement, or using a device type.

Example 15 includes a non-transitory computer readable medium comprising instructions that, when executed, cause programmable circuitry to at least select at least one constraint equation corresponding to one or more events, the one or more events corresponding to first audience members and second audience members, the first audience members to include the second audience members, solve the at least one constraint equation to determine one or more constraint parameter values, the one or more constraint parameter values corresponding to the one or more events, and determine, based on one or more intermediate equations and the one or more constraint parameter values, an event audience size and an event duration corresponding to (a) the first audience members and (b) a combination of the one or more events and one or more demographics.

Example 16 includes the non-transitory computer readable medium of example 15, wherein the event audience size is a first event audience size, the event duration is a first event duration, and the instructions are to cause the programmable circuitry to determine the first event audience size based on aggregate duration values, second event audience sizes, and second event durations, the aggregate duration values corresponding to the first audience members, the second event audience sizes and the second event durations corresponding to the second audience members and to the combination of the one or more events and the one or more demographics.

Example 17 includes the non-transitory computer readable medium of example 16, wherein the instructions are to cause the programmable circuitry to determine the one or more constraint parameter values based on a range, the range based on a ratio of the second event audience sizes to the second event durations.

Example 18 includes the non-transitory computer readable medium of example 16, wherein the instructions are to cause the programmable circuitry to calculate summary parameter values based on the second event audience sizes, the second event durations, and universe estimates corresponding to the one or more demographics.

Example 19 includes the non-transitory computer readable medium of example 18, wherein the instructions are to cause the programmable circuitry to determine output parameter values by iteratively solving the one or more intermediate equations based on the summary parameter values and the one or more constraint parameter values, the output parameter values including the first event audience size and the first event duration.

Example 20 includes the non-transitory computer readable medium of example 15, wherein the instructions are to cause the programmable circuitry to generate a report including the event audience size and the event duration.

Example 21 includes the non-transitory computer readable medium of example 15, wherein the one or more events include at least one of accessing a website, accessing an advertisement, or using a device type.

Example 22 includes an apparatus comprising means for selecting at least one constraint equation corresponding to one or more events, the one or more events corresponding to first audience members and second audience members, the first audience members to include the second audience members, means for determining one or more constraint parameter values by solving the at least one constraint equation, the one or more constraint parameter values corresponding to the one or more events, and means for determining an event audience size and an event duration based on one or more intermediate equations and the one or more constraint parameter values, the event audience size and the event duration corresponding to (a) the first audience members and (b) a combination of the one or more events and one or more demographics.

Example 23 includes the apparatus of example 22, wherein the event audience size is a first event audience size, the event duration is a first event duration, the means for determining the event audience size and the event duration to determine the first event audience size based on aggregate duration values, second event audience sizes, and second event durations, the aggregate duration values corresponding to the first audience members, and the second event audience sizes and the second event durations corresponding to the second audience members and to the combination of the one or more events and the one or more demographics.

Example 24 includes the apparatus of example 23, wherein the means for determining the one or more constraint parameter values is to determine the one or more constraint parameter values based on a range, the range based on a ratio of the second event audience sizes second event durations.

Example 25 includes the apparatus of example 23, further including means for calculating summary parameter values based on the second event audience sizes, the second event durations, and universe estimates corresponding to the one or more demographics.

Example 26 includes the apparatus of example 25, wherein the means for determining the event audience size and the event duration is to determine output parameter values by iteratively solving the one or more intermediate equations based on the summary parameter values and the one or more constraint parameter values, the output parameter values including the first event audience size and the first event duration.

Example 27 includes the apparatus of example 22, further including means for generating a report including the event audience size and the event duration.

Example 28 includes the apparatus of example 22, wherein the one or more events include at least one of accessing a website, accessing an advertisement, or using a device type.

Example 29 includes a method comprising selecting at least one constraint equation corresponding to one or more events, the one or more events corresponding to first audience members and second audience members, the first audience members to include the second audience members, solving the at least one constraint equation to determine one or more constraint parameter values, the one or more constraint parameter values corresponding to the one or more events, and determining, based on one or more intermediate equations and the one or more constraint parameter values, an event audience size and an event duration corresponding to (a) the first audience members and (b) a combination of the one or more events and one or more demographics.

Example 30 includes the method of example 29, wherein the event audience size is a first event audience size, the event duration is a first event duration, further including determining the first event audience size based on aggregate duration values, second event audience sizes, and second event durations, the aggregate duration values corresponding to the first audience members, and the second event audience sizes and the second event durations corresponding to the second audience members and to the combination of the one or more events and the one or more demographics.

Example 31 includes the method of example 30, further including determining the one or more constraint parameter values based on a range, the range based on a ratio of the second event audience sizes to the second event durations.

Example 32 includes the method of example 30, further including calculating summary parameter values based on the second event audience sizes, the second event durations, and universe estimates corresponding to the one or more demographics.

Example 33 includes the method of example 32, further including determining output parameter values by iteratively solving the one or more intermediate equations based on the summary parameter values and the one or more constraint parameter values, the output parameter values including the first event audience size and the first event duration.

Example 34 includes the method of example 29, further including generating a report including the event audience size and the event duration.

Example 35 includes the method of example 29, wherein the one or more events include at least one of accessing a website, accessing an advertisement, or using a device type.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
constraint equation control circuitry to select at least one constraint equation corresponding to one or more events, the one or more events corresponding to first audience members and second audience members, the first audience members to include the second audience members;
constraint parameter estimation circuitry to solve the at least one constraint equation to determine one or more constraint parameter values, the one or more constraint parameter values corresponding to the one or more events; and
output generation circuitry to determine, based on one or more intermediate equations and the one or more constraint parameter values, an event audience size and an event duration corresponding to (a) the first audience members and (b) a combination of the one or more events and one or more demographics.

2. The apparatus of claim 1, wherein the event audience size is a first event audience size, the event duration is a first event duration, the output generation circuitry to determine the first event audience size based on aggregate duration values, second event audience sizes, and second event durations, the aggregate duration values corresponding to the first audience members, and the second event audience sizes and the second event durations corresponding to the second audience members and to the combination of the one or more events and the one or more demographics.

3. The apparatus of claim 2, wherein the constraint parameter estimation circuitry is to determine the one or more constraint parameter values based on a range, the range based on a ratio of the second event audience sizes to the second event durations.

4. The apparatus of claim 2, further including summary parameter calculation circuitry to calculate summary parameter values based on the second event audience sizes, the second event durations, and universe estimates corresponding to the one or more demographics.

5. The apparatus of claim 4, wherein the output generation circuitry is to determine output parameter values by iteratively solving the one or more intermediate equations based on the summary parameter values and the one or more constraint parameter values, the output parameter values including the first event audience size and the first event duration.

6. The apparatus of claim 1, further including report generation circuitry to generate a report including the event audience size and the event duration.

7. The apparatus of claim 1, wherein the one or more events include at least one of accessing a website, accessing an advertisement, or using a device type.

8. A system comprising:
memory;
programmable circuitry; and
instructions to cause the programmable circuitry to:
select at least one constraint equation corresponding to one or more events, the one or more events corresponding to first audience members and second audience members, the first audience members to include the second audience members;
solve the at least one constraint equation to determine one or more constraint parameter values, the one or more constraint parameter values corresponding to the one or more events; and
determine, based on one or more intermediate equations and the one or more constraint parameter values, an event audience size and an event duration corresponding to (a) the first audience members and (b) a combination of the one or more events and one or more demographics.

9. The system of claim 8, wherein the event audience size is a first event audience size, the event duration is a first event duration, the programmable circuitry to determine the first event audience size based on aggregate duration values, second event audience sizes, and second event durations, the aggregate duration values corresponding to the first audience members, and the second event audience sizes and the second event durations corresponding to the second audience members and to the combination of the one or more events and the one or more demographics.

10. The system of claim 9, wherein the programmable circuitry is to determine the one or more constraint parameter values based on a range, the range based on a ratio of the second event audience sizes to the second event durations.

11. The system of claim 9, wherein the programmable circuitry is to calculate summary parameter values based on the second event audience sizes, the second event durations, and universe estimates corresponding to the one or more demographics.

12. The system of claim 11, wherein the programmable circuitry is to determine output parameter values by iteratively solving the one or more intermediate equations based on the summary parameter values and the one or more constraint parameter values, the output parameter values including the first event audience size and the first event duration.

13. The system of claim 8, wherein the programmable circuitry is to generate a report including the event audience size and the event duration.

14. The system of claim 8, wherein the one or more events include at least one of accessing a website, accessing an advertisement, or using a device type.

15. A non-transitory computer readable medium comprising instructions that, when executed, cause programmable circuitry to at least:
select at least one constraint equation corresponding to one or more events, the one or more events corresponding to first audience members and second audience members, the first audience members to include the second audience members;
solve the at least one constraint equation to determine one or more constraint parameter values, the one or more constraint parameter values corresponding to the one or more events; and
determine, based on one or more intermediate equations and the one or more constraint parameter values, an event audience size and an event duration corresponding to (a) the first audience members and (b) a combination of the one or more events and one or more demographics.

16. The non-transitory computer readable medium of claim 15, wherein the event audience size is a first event audience size, the event duration is a first event duration, and the instructions are to cause the programmable circuitry to determine the first event audience size based on aggregate duration values, second event audience sizes, and second event durations, the aggregate duration values corresponding to the first audience members, the second event audience sizes and the second event durations corresponding to the second audience members and to the combination of the one or more events and the one or more demographics.

17. The non-transitory computer readable medium of claim 16, wherein the instructions are to cause the programmable circuitry to determine the one or more constraint parameter values based on a range, the range based on a ratio of the second event audience sizes to the second event durations.

18. The non-transitory computer readable medium of claim 16, wherein the instructions are to cause the programmable circuitry to calculate summary parameter values based on the second event audience sizes, the second event durations, and universe estimates corresponding to the one or more demographics.

19. The non-transitory computer readable medium of claim 18, wherein the instructions are to cause the programmable circuitry to determine output parameter values by iteratively solving the one or more intermediate equations based on the summary parameter values and the one or more constraint parameter values, the output parameter values including the first event audience size and the first event duration.

20. The non-transitory computer readable medium of claim 15, wherein the instructions are to cause the programmable circuitry to generate a report including the event audience size and the event duration.

21. The non-transitory computer readable medium of claim 15, wherein the one or more events include at least one of accessing a website, accessing an advertisement, or using a device type.

22-35. (canceled)
